(19) United States
(12) Patent Application Publication
(10) Pub. No.: US 2026/0107004 A1
(43) Pub. Date: Apr. 16, 2026

(54) FLEXIBLE CONTEXT-BASED ADAPTIVE BINARY ARITHMETIC CODING (CABAC) PARAMETERS, HYBRID CONTEXT WITH MULTIPLE PROBABILITY UPDATE, AND LEARNING BASED CONTEXT DERIVATION IN CABAC

(71) Applicant: Tencent America LLC, Palo Alto, CA (US)

(72) Inventors: Ziyue XIANG, Palo Alto, CA (US); Lien-fei CHEN, Palo Alto, CA (US); Yonguk YOON, Palo Alto, CA (US); Yifan WANG, Palo Alto, CA (US); Shan LIU, San Jose, CA (US); Biao WANG, San Jose, CA (US); Roman CHERNYAK, Santa Clara, CA (US); Motong XU, Palo Alto, CA (US); Xin ZHAO, San Jose, CA (US)

(73) Assignee: Tencent America LLC, Palo Alto, CA (US)

(21) Appl. No.: 19/255,932

(22) Filed: Jun. 30, 2025

Related U.S. Application Data
(60) Provisional application No. 63/666,618, filed on Jul. 1, 2024.
(60) Provisional application No. 63/684,175, filed on Aug. 16, 2024.
(60) Provisional application No. 63/714,681, filed on Oct. 31, 2024.

(51) Int. Cl. H04N 19/44; H04N 19/13; H04N 19/91

(52) U.S. Cl. CPC H04N 19/44; H04N 19/13; H04N 19/91

(57) ABSTRACT

Methods and apparatuses for video decoding and video encoding are provided. A method for video decoding includes receiving coding information in a video bitstream. The coding information indicates that a current binary symbol associated with a syntax element of a block is entropy coded using context-adaptive binary arithmetic coding (CABAC) based on a set of contexts. Each context in the set of contexts corresponds to a probability estimation rule for the CABAC. A set of initial CABAC parameters is determined from a plurality sets of initial CABAC parameters of a context in the set of contexts. The method for video decoding includes entropy decoding, based on the determined set of initial CABAC parameters, the current binary symbol using the CABAC.

### RELATED APPLICATIONS

The present application claims the benefit of priority to U.S. Provisional Application No. 63/666,618, “FLEXIBLE CABAC PARAMETERS” filed on Jul. 1, 2024, U.S. Provisional Application No. 63/684,175, “USING LEARNING BASED METHODS FOR CONTEXT DERIVATION” filed on Aug. 16, 2024, and U.S. Provisional Application No. 63/714,681, “METHOD AND APPARATUS FOR HYBRID CONTEXT WITH MULTIPLE PROBABILITY UPDATE AND PARAMETER DERIVATION” filed on Oct. 31, 2024, which are incorporated by reference herein in their entirety.

### TECHNICAL FIELD

The present disclosure describes aspects generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Image/video compression may help transmit image/video data across different devices, storage and networks with minimal quality degradation. In some examples, video codec technology may compress video based on spatial and temporal redundancy. In an example, a video codec may use techniques referred to as intra prediction that may compress an image based on spatial redundancy. For example, the intra prediction may use reference data from the current picture under reconstruction for sample prediction. In another example, a video codec may use techniques referred to as inter prediction that may compress an image based on temporal redundancy. For example, the inter prediction may predict samples in a current picture from a previously reconstructed picture with motion compensation. The motion compensation may be indicated by a motion vector (MV).

### SUMMARY

Aspects of the disclosure include methods and apparatuses for video encoding/decoding.

Aspects of the disclosure provide a method for video decoding in which coding information in a video bitstream is received. The coding information indicates that a current binary symbol associated with a syntax element of a block is entropy coded using context-adaptive binary arithmetic coding (CABAC) based on a set of contexts. Each context in the set of contexts corresponds to a probability estimation rule for the CABAC. A set of initial CABAC parameters is determined from a plurality sets of initial CABAC parameters of a context in the set of contexts. The current binary symbol is entropy decoded based on the determined set of initial CABAC parameters using the CABAC.

Aspects of the disclosure provide a method for video decoding in which coding information in a video bitstream is received. The coding information indicates that a current binary symbol associated with a syntax element of a block is entropy coded using CABAC based on a set of contexts. Each context in the set of contexts corresponds to a probability estimation rule for the CABAC. A set of initial CABAC parameters is determined from a plurality sets of initial CABAC parameters of a context in the set of contexts. The current binary symbol is entropy decoded based on the determined set of initial CABAC parameters using the CABAC. One or more initial CABAC parameters in a set of initial CABAC parameters of a context in the set of contexts are updated based on parameter information signaled in the coding information to determine an updated set of initial CABAC parameters of the context. The updated set of initial CABAC parameters includes one or more updated initial CABAC parameters. The current binary symbol is entropy decoded based on the updated set of initial CABAC parameters using the CABAC.

Aspects of the disclosure provide a method for video decoding in which coding information in a video bitstream is received. The coding information indicates that a current binary symbol associated with a syntax element of a block is entropy coded using CABAC based on a context with one or more probability estimation windows. One of (i) a probability update rule for one of the one or more probability estimation windows and (ii) at least one probability estimate parameter of the probability update rule is determined. The current binary symbol is entropy decoded based on the one of (i) the probability update rule and (ii) the probability estimate parameter of the probability update rule using the CABAC.

Aspects of the disclosure also provide an apparatus for video decoding. The apparatus for video decoding includes processing circuitry configured to implement any of the described methods for video decoding.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of an example of a block diagram of a communication system (100).

FIG. 2 is a schematic illustration of an example of a block diagram of a decoder.

FIG. 3 is a schematic illustration of an example of a block diagram of an encoder.

FIG. 4 shows an example of CABAC according to an aspect of the disclosure.

FIG. 5 shows an example of a context derivation rule for a syntax element according to an aspect of the disclosure.

FIG. 6 shows an example of using the learning based methods for context derivation according to an aspect of the disclosure.

FIG. 7 shows a flow chart outlining a process (700) according to an aspect of the disclosure.

FIG. 8 shows a flow chart outlining a process (800) according to an aspect of the disclosure.

FIG. 9 shows a flow chart outlining a process (900) according to an aspect of the disclosure.

FIG. 10 is a schematic illustration of a computer system in accordance with an aspect.

### DETAILED DESCRIPTION

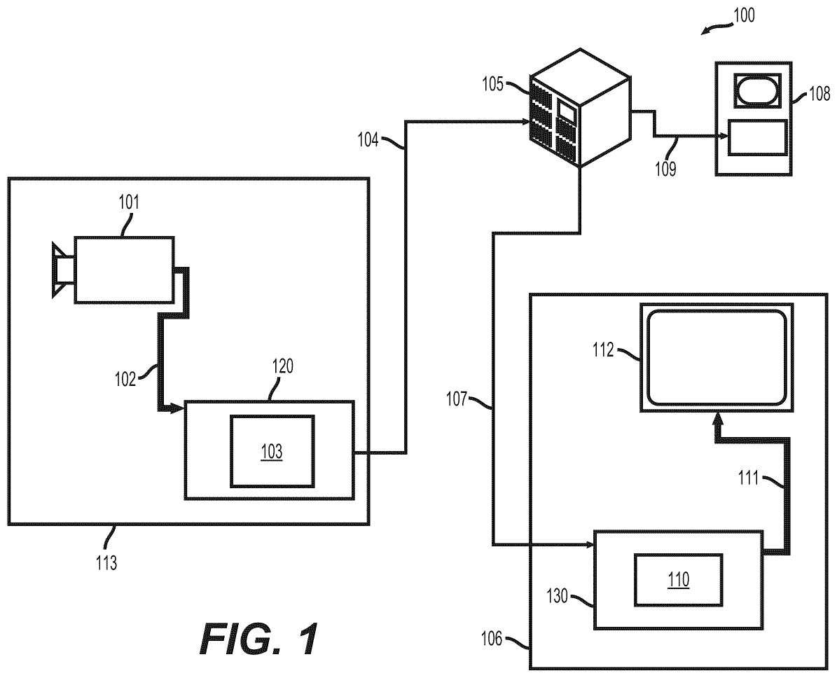

FIG. 1 shows a block diagram of a video processing system (100) in some examples. The video processing system (100) is an example of an application for the disclosed subject matter, a video encoder and a video decoder in a streaming environment. The disclosed subject matter may be equally applicable to other video enabled applications, including, for example, video conferencing, digital TV, streaming services, storing of compressed video on digital media including CD, DVD, memory stick and the like, and so on.

The video processing system (100) includes a capture subsystem (113), that may include a video source (101), for example a digital camera, creating for example a stream of video pictures (102) that are uncompressed. In an example, the stream of video pictures (102) includes samples that are taken by the digital camera. The stream of video pictures (102), depicted as a bold line to emphasize a high data volume when compared to encoded video data (104) (or coded video bitstreams), may be processed by an electronic device (120) that includes a video encoder (103) coupled to the video source (101). The video encoder (103) may include hardware, software, or a combination thereof to enable or implement aspects of the disclosed subject matter as described in more detail below. The encoded video data (104) (or encoded video bitstream), depicted as a thin line to emphasize the lower data volume when compared to the stream of video pictures (102), may be stored on a streaming server (105) for future use. One or more streaming client subsystems, such as client subsystems (106) and (108) in FIG. 1 may access the streaming server (105) to retrieve copies (107) and (109) of the encoded video data (104). A client subsystem (106) may include a video decoder (110), for example, in an electronic device (130). The video decoder (110) decodes the incoming copy (107) of the encoded video data and creates an outgoing stream of video pictures (111) that may be rendered on a display (112) (e.g., display screen) or other rendering device (not depicted). In some streaming systems, the encoded video data (104), (107), and (109) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (120) and (130) can include other components (not shown). For example, the electronic device (120) can include a video decoder (not shown) and the electronic device (130) can include a video encoder (not shown) as well.

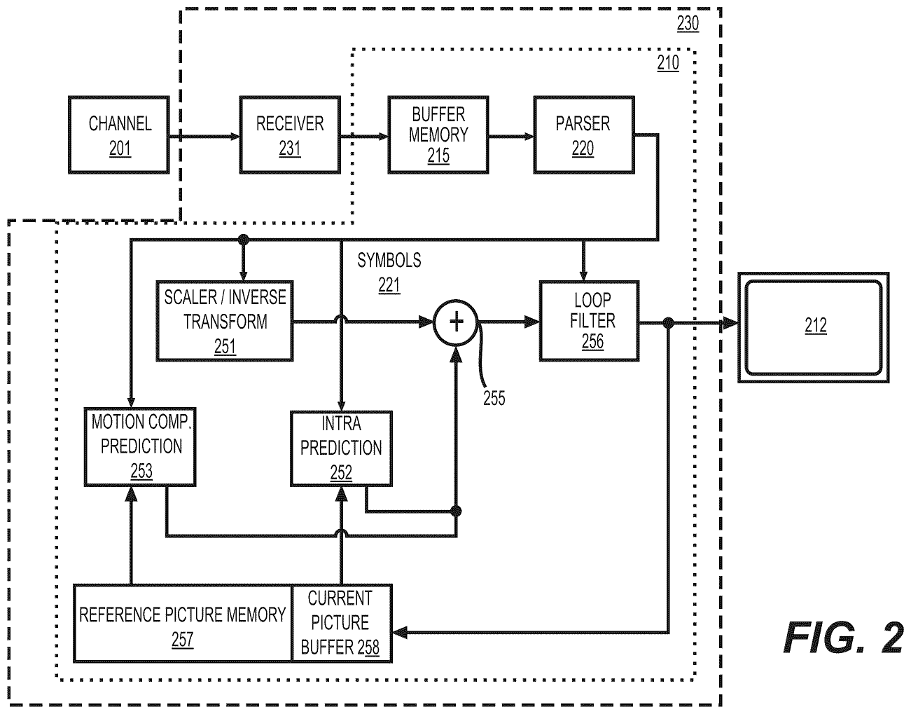

FIG. 2 shows an example of a block diagram of a video decoder (210). The video decoder (210) can be included in an electronic device (230). The electronic device (230) can include a receiver (231) (e.g., receiving circuitry). The video decoder (210) can be used in the place of the video decoder (110) in the FIG. 1 example.

The receiver (231) may receive one or more coded video sequences, included in a bitstream for example, to be decoded by the video decoder (210). In an aspect, one coded video sequence is received at a time, where the decoding of each coded video sequence is independent from the decoding of other coded video sequences. The coded video sequence may be received from a channel (201), which may be a hardware/software link to a storage device which stores the encoded video data. The receiver (231) may receive the encoded video data with other data, for example, coded audio data and/or ancillary data streams, that may be forwarded to their respective using entities (not depicted). The receiver (231) may separate the coded video sequence from the other data. To combat network jitter, a buffer memory (215) may be coupled in between the receiver (231) and an entropy decoder/parser (220) (“parser (220)” henceforth). In certain applications, the buffer memory (215) is part of the video decoder (210). In others, it can be outside of the video decoder (210) (not depicted). In still others, there can be a buffer memory (not depicted) outside of the video decoder (210), for example to combat network jitter, and in addition another buffer memory (215) inside the video decoder (210), for example to handle playout timing. When the receiver (231) is receiving data from a store/forward device of sufficient bandwidth and controllability, or from an isosynchronous network, the buffer memory (215) may not be needed, or can be small. For use on best effort packet networks such as the Internet, the buffer memory (215) may be required, can be comparatively large and can be advantageously of adaptive size, and may partially be implemented in an operating system or similar elements (not depicted) outside of the video decoder (210).

The video decoder (210) may include the parser (220) to reconstruct symbols (221) from the coded video sequence. Categories of those symbols include information used to manage operation of the video decoder (210), and potentially information to control a rendering device such as a render device (212) (e.g., a display screen) that is not an integral part of the electronic device (230) but can be coupled to the electronic device (230), as shown in FIG. 2. The control information for the rendering device(s) may be in the form of Supplemental Enhancement Information (SEI) messages or Video Usability Information (VUI) parameter set fragments (not depicted). The parser (220) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (220) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (220) may also extract from the coded video sequence information such as transform coefficients, quantizer parameter values, motion vectors, and so forth.

The parser (220) may perform an entropy decoding/parsing operation on the video sequence received from the buffer memory (215), so as to create symbols (221).

Reconstruction of the symbols (221) can involve multiple different units depending on the type of the coded video picture or parts thereof (such as: inter and intra picture, inter and intra block), and other factors. Which units are involved, and how, can be controlled by subgroup control information parsed from the coded video sequence by the parser (220). The flow of such subgroup control information between the parser (220) and the multiple units below is not depicted for clarity.

Beyond the functional blocks already mentioned, the video decoder (210) can be conceptually subdivided into a number of functional units as described below. In a practical implementation operating under commercial constraints, many of these units interact closely with each other and can, partly, be integrated into each other. However, for the purpose of describing the disclosed subject matter, the conceptual subdivision into the functional units below is appropriate.

A first unit is the scaler/inverse transform unit (251). The scaler/inverse transform unit (251) receives a quantized transform coefficient as well as control information, including which transform to use, block size, quantization factor, quantization scaling matrices, etc. as symbol(s) (221) from the parser (220). The scaler/inverse transform unit (251) can output blocks comprising sample values, that can be input into aggregator (255).

In some cases, the output samples of the scaler/inverse transform unit (251) can pertain to an intra coded block. The intra coded block is a block that is not using predictive information from previously reconstructed pictures, but can use predictive information from previously reconstructed parts of the current picture. Such predictive information can be provided by an intra picture prediction unit (252). In some cases, the intra picture prediction unit (252) generates a block of the same size and shape of the block under reconstruction, using surrounding already reconstructed information fetched from the current picture buffer (258). The current picture buffer (258) buffers, for example, partly reconstructed current picture and/or fully reconstructed current picture. The aggregator (255), in some cases, adds, on a per sample basis, the prediction information the intra prediction unit (252) has generated to the output sample information as provided by the scaler/inverse transform unit (251).

In other cases, the output samples of the scaler/inverse transform unit (251) can pertain to an inter coded, and potentially motion compensated, block. In such a case, a motion compensation prediction unit (253) can access reference picture memory (257) to fetch samples used for prediction. After motion compensating the fetched samples in accordance with the symbols (221) pertaining to the block, these samples can be added by the aggregator (255) to the output of the scaler/inverse transform unit (251) (in this case called the residual samples or residual signal) so as to generate output sample information. The addresses within the reference picture memory (257) from where the motion compensation prediction unit (253) fetches prediction samples can be controlled by motion vectors, available to the motion compensation prediction unit (253) in the form of symbols (221) that can have, for example X, Y, and reference picture components. Motion compensation also can include interpolation of sample values as fetched from the reference picture memory (257) when sub-sample exact motion vectors are in use, motion vector prediction mechanisms, and so forth.

The output samples of the aggregator (255) can be subject to various loop filtering techniques in the loop filter unit (256). Video compression technologies can include in-loop filter technologies that are controlled by parameters included in the coded video sequence (also referred to as coded video bitstream) and made available to the loop filter unit (256) as symbols (221) from the parser (220). Video compression can also be responsive to meta-information obtained during the decoding of previous (in decoding order) parts of the coded picture or coded video sequence, as well as responsive to previously reconstructed and loop-filtered sample values.

The output of the loop filter unit (256) can be a sample stream that can be output to the render device (212) as well as stored in the reference picture memory (257) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (220)), the current picture buffer (258) can become a part of the reference picture memory (257), and a fresh current picture buffer can be reallocated before commencing the reconstruction of the following coded picture.

The video decoder (210) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an aspect, the receiver (231) may receive additional (redundant) data with the encoded video. The additional data may be included as part of the coded video sequence(s). The additional data may be used by the video decoder (210) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

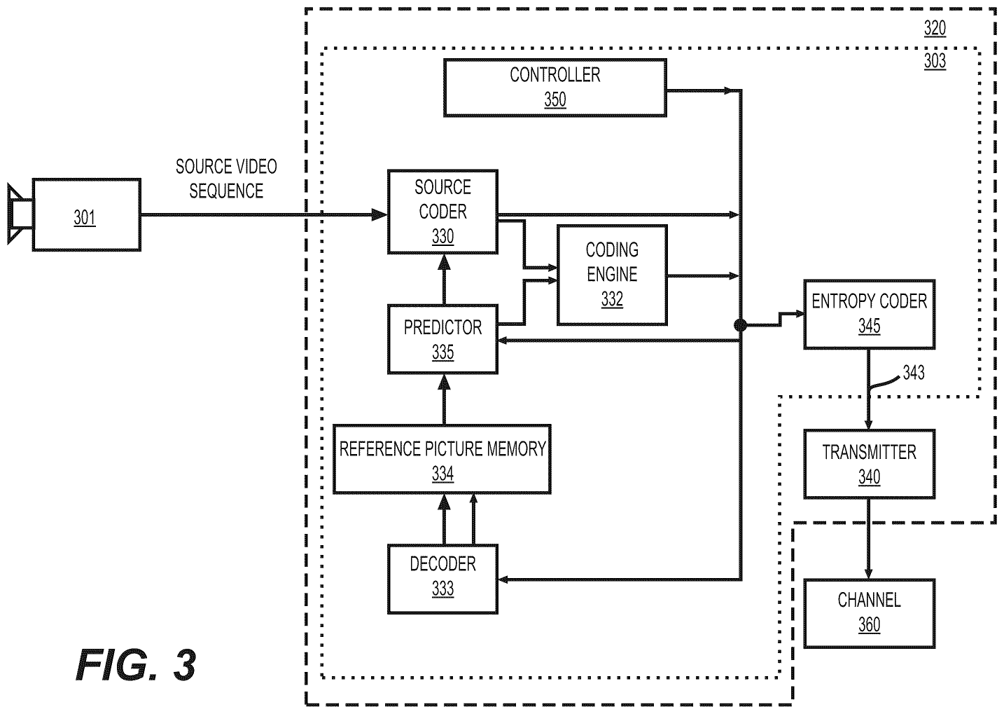

FIG. 3 shows an example of a block diagram of a video encoder (303). The video encoder (303) is included in an electronic device (320). The electronic device (320) includes a transmitter (340) (e.g., transmitting circuitry). The video encoder (303) can be used in the place of the video encoder (103) in the FIG. 1 example.

The video encoder (303) may receive video samples from a video source (301) (that is not part of the electronic device (320) in the FIG. 3 example) that may capture video image(s) to be coded by the video encoder (303). In another example, the video source (301) is a part of the electronic device (320).

The video source (301) may provide the source video sequence to be coded by the video encoder (303) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (301) may be a storage device storing previously prepared video. In a videoconferencing system, the video source (301) may be a camera that captures local image information as a video sequence. Video data may be provided as a plurality of individual pictures that impart motion when viewed in sequence. The pictures themselves may be organized as a spatial array of pixels, wherein each pixel can include one or more samples depending on the sampling structure, color space, etc. in use. The description below focuses on samples.

According to an aspect, the video encoder (303) may code and compress the pictures of the source video sequence into a coded video sequence (343) in real time or under any other time constraints as required. Enforcing appropriate coding speed is one function of a controller (350). In some aspects, the controller (350) controls other functional units as described below and is functionally coupled to the other functional units. The coupling is not depicted for clarity. Parameters set by the controller (350) can include rate control related parameters (picture skip, quantizer, lambda value of rate-distortion optimization techniques, . . . ), picture size, group of pictures (GOP) layout, maximum motion vector search range, and so forth. The controller (350) can be configured to have other suitable functions that pertain to the video encoder (303) optimized for a certain system design.

In some aspects, the video encoder (303) is configured to operate in a coding loop. As an oversimplified description, in an example, the coding loop can include a source coder (330) (e.g., responsible for creating symbols, such as a symbol stream, based on an input picture to be coded, and a reference picture(s)), and a (local) decoder (333) embedded in the video encoder (303). The decoder (333) reconstructs the symbols to create the sample data in a similar manner as a (remote) decoder also would create. The reconstructed sample stream (sample data) is input to the reference picture memory (334). As the decoding of a symbol stream leads to bit-exact results independent of decoder location (local or remote), the content in the reference picture memory (334) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (333) can be the same as a “remote” decoder, such as the video decoder (210), which has already been described in detail above in conjunction with FIG. 2. Briefly referring also to FIG. 2, however, as symbols are available and encoding/decoding of symbols to a coded video sequence by an entropy coder (345) and the parser (220) can be lossless, the entropy decoding parts of the video decoder (210), including the buffer memory (215), and parser (220) may not be fully implemented in the local decoder (333).

In an aspect, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (330) may perform motion compensated predictive coding, which codes an input picture predictively with reference to one or more previously coded picture from the video sequence that were designated as “reference pictures.” In this manner, the coding engine (332) codes differences between pixel blocks of an input picture and pixel blocks of reference picture(s) that may be selected as prediction reference(s) to the input picture.

The local video decoder (333) may decode coded video data of pictures that may be designated as reference pictures, based on symbols created by the source coder (330). Operations of the coding engine (332) may advantageously be lossy processes. When the coded video data may be decoded at a video decoder (not shown in FIG. 3), the reconstructed video sequence typically may be a replica of the source video sequence with some errors. The local video decoder (333) replicates decoding processes that may be performed by the video decoder on reference pictures and may cause reconstructed reference pictures to be stored in the reference picture memory (334). In this manner, the video encoder (303) may store copies of reconstructed reference pictures locally that have common content as the reconstructed reference pictures that will be obtained by a far-end video decoder (absent transmission errors).

The predictor (335) may perform prediction searches for the coding engine (332). That is, for a new picture to be coded, the predictor (335) may search the reference picture memory (334) for sample data (as candidate reference pixel blocks) or certain metadata such as reference picture motion vectors, block shapes, and so on, that may serve as an appropriate prediction reference for the new pictures. The predictor (335) may operate on a sample block-by-pixel block basis to find appropriate prediction references. In some cases, as determined by search results obtained by the predictor (335), an input picture may have prediction references drawn from multiple reference pictures stored in the reference picture memory (334).

The controller (350) may manage coding operations of the source coder (330), including, for example, setting of parameters and subgroup parameters used for encoding the video data.

Output of all aforementioned functional units may be subjected to entropy coding in the entropy coder (345). The entropy coder (345) translates the symbols as generated by the various functional units into a coded video sequence, by applying lossless compression to the symbols according to technologies such as Huffman coding, variable length coding, arithmetic coding, and so forth.

The transmitter (340) may buffer the coded video sequence(s) as created by the entropy coder (345) to prepare for transmission via a communication channel (360), which may be a hardware/software link to a storage device which would store the encoded video data. The transmitter (340) may merge coded video data from the video encoder (303) with other data to be transmitted, for example, coded audio data and/or ancillary data streams (sources not shown).

The controller (350) may manage operation of the video encoder (303). During coding, the controller (350) may assign to each coded picture a certain coded picture type, which may affect the coding techniques that may be applied to the respective picture. For example, pictures often may be assigned as one of the following picture types:

An Intra Picture (I picture) may be coded and decoded without using any other picture in the sequence as a source of prediction. Some video codecs allow for different types of intra pictures, including, for example Independent Decoder Refresh (“IDR”) Pictures.

A predictive picture (P picture) may be coded and decoded using intra prediction or inter prediction using a motion vector and reference index to predict the sample values of each block.

A bi-directionally predictive picture (B Picture) may be coded and decoded using intra prediction or inter prediction using two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (303) may perform coding operations according to a predetermined video coding technology or standard, such as ITU-T Rec. H.265. In its operation, the video encoder (303) may perform various compression operations, including predictive coding operations that exploit temporal and spatial redundancies in the input video sequence. The coded video data, therefore, may conform to a syntax specified by the video coding technology or standard being used.

In an aspect, the transmitter (340) may transmit additional data with the encoded video. The source coder (330) may include such data as part of the coded video sequence. Additional data may include temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes use of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some aspects, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some aspects of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an aspect, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

It is noted that the video encoders (103) and (303), and the video decoders (110) and (210) can be implemented using any suitable technique. In an aspect, the video encoders (103) and (303) and the video decoders (110) and (210) can be implemented using one or more integrated circuits. In another aspect, the video encoders (103) and (303), and the video decoders (110) and (210) can be implemented using one or more processors that execute software instructions.

Video coding has been widely used in many applications such as broadcasting, video recording, video streaming, and the like. Various video coding standards such as H.264, H.265/HEVC, H.266/VVC, AV1, AVS, and the like are adopted in the video applications. A video codec may include multiple modules, including partitioning, intra/inter prediction, transform coding, quantization, entropy coding, in loop filtering, and the like. This disclose describes a set of methods for video compression, more specifically related to entropy coding.

In various video coding standards, arithmetic coding is used in entropy coding to efficiently compress binary data. In various aspects, real-world implementations of arithmetic coding in video coding standards such as Context-based Adaptive Binary Arithmetic Coding (CABAC) utilize the spatial and temporal correlation of video signals to improve coding efficiency. Entropy coding such as entropy encoding and/or entropy decoding may be implemented using CABAC. CABAC is based on arithmetic coding.

Arithmetic coding may be used to code a sequence of binary values. The sequence of binary values may be referred to as a string of binary symbols (or bins). A binary symbol may also be referred to as a bin. After arithmetic coding, the sequence (e.g., the entire sequence) can be represented by a real-valued interval. Arithmetic coding may include two components: probability estimation and codeword mapping. In probability estimation, in some examples, a probability of a binary symbol (or a bin) being equal to one is estimated. In codeword mapping, in some examples, a current interval is subdivided based on the result of the probability estimation.

In CABAC, a context model may provide a probability estimate for a binary symbol (e.g., a binary symbol in a sequence of binary symbols) based on one or more probability estimates of previous binary symbols in the sequence of binary symbols. A context model may also be referred to as a probability model, a probability estimation model, a probability estimation rule, a probability estimate method, a probability update rule, or the like. A context model may be determined for the binary symbol to be entropy coded.

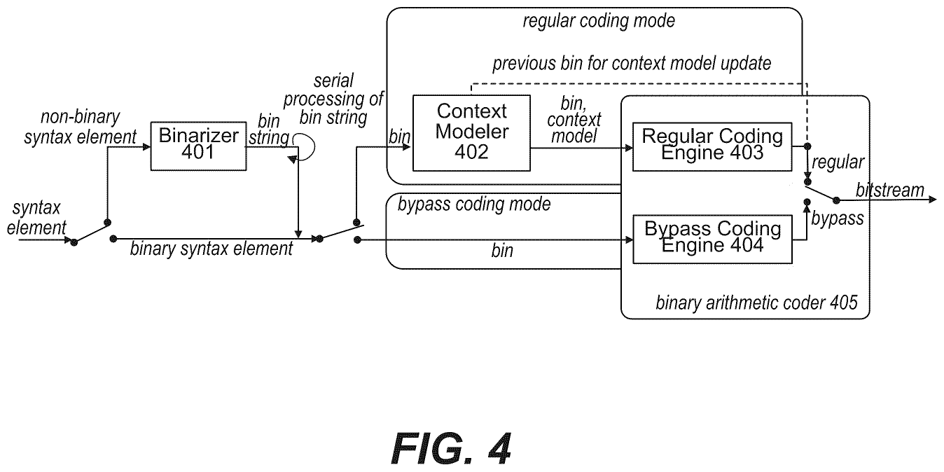

FIG. 4 shows an example of CABAC according to an aspect of the disclosure. CABAC can have multiple probability modes for different contexts. In CABAC, coding a syntax can include one or more stages, such as binarization, context modeling, and/or binary arithmetic coding. One or more stages can be omitted or modified. Additional stage(s) may be added.

In some embodiments, non-binary syntax or non-binary syntax element(s), can be converted into binary, such as a sequence of binary symbols (also referred to as a bin string), by binarization with a binarizer (401). In an example, a bin string is generated based on a non-binary syntax element. For a binary symbol (or a bin) in a bin string, a coder can select which probability estimation model to use (context modeling), and may use information from nearby elements to optimize a probability estimate. Arithmetic coding can be applied to compress the data, for example, with a binary arithmetic coder (405). For some binary symbols, if the probability of being “1” or “0” is equal without a good context to better estimate the probability, the binary symbols can be coded without using a context model, and thus a bypass coding is used. The example or a variation shown in FIG. 4 can be used in video coding such as in various video coding standards. The context modeling can provide estimates of conditional probabilities of the coding symbols. In some examples, utilizing suitable context models, a given inter-symbol redundancy is exploited by switching between different probability estimation models according to already-coded symbols in the neighborhood of the current symbol to be encoded.

In an aspect, CABAC uses binary arithmetic coding, and thus only binary decisions (1 or 0) are coded (e.g., encoded). In the binarization, a non-binary-valued syntax element (e.g. a transform coefficient or a motion vector) may be binarized or converted into a binary with the binarizer (401) prior to arithmetic coding. Binarization can be skipped if a syntax element (e.g., a flag) is a binary symbol. Bins from the binarizer (401) can be input to the binary arithmetic coding engine.

In an example, binary symbols (or bins) in a bin string are processed sequentially. One or more stages in CABAC can be repeated for each binary symbol of a bin string.

A coding mode decision between a regular coding mode and a bypass coding mode may be made for each binary symbol, for example, based on a statistical correlation between the respective binary symbol and other binary symbols in the bin string. If the bypass coding mode is selected, the regular binary arithmetic encoding process can be bypassed for the binary symbols. In the bypass coding mode, the binary symbol is coded with a bypass coding engine (404). For example, arithmetic coding based on fixed probably model may be used, such as using Golomb-Rice.

In the regular coding mode, the context modeler (402) may select a context model, such as a probability estimation model, for a binary symbol. A context model is a probability estimation model for one or more binary symbols of a binarized syntax element. In an example, the context model is chosen from a selection of available context models depending on statistics of recently coded data symbols. The context model can store the probability of each binary symbol being “1” or “0”.

When the context model is selected adaptively, different binary symbols in the bin string may have different context models.

The context modeler (402) may output the binary symbol (or bin) and the context model (e.g., the probability state). The selected context model may be updated based on an actual coded value (e.g., if the binary symbol value is “1”, the frequency count of “1”s is increased).

An arithmetic coder (405) can encode each bin according to the selected probability estimation model. In an example, two sub-ranges (corresponding to “0” and “1”) are used for each bin. When the bypass coding mode is selected, the bypass coding engine (404) is used to code a bin. When the regular coding mode is selected, the regular coding engine (403) is selected to code a bin. In an example, the regular coding mode is applied to code bins where the probability of a value of a bin is predictable given the values of previously coded bins. The bypass coding engine (404) may be a fast branch of the coding engine with a considerably reduced complexity while the regular coding engine (403) encodes the given bin value depends on an actual state of the associated adaptive probability model that is passed along with the bin value.

When the regular coding mode is selected, the selected context model can be updated based on the actual coded value (e.g., if the bin value was “1”, the frequency count of “1”s is increased).

In CABAC, each binary symbol may be coded with a selected set of contexts. In an aspect, each context in the set of contexts corresponds to a probability estimation model. In an aspect, each context has its own parameters (e.g., CABAC parameters). The CABAC parameters may include an initial probability estimate, a probability estimation window size (also referred to as a window size), a probability transition rate, multi-hypothesis probability transition weight(s), and the like. In an aspect, the probability transition rate indicates the probability estimation window size.

The CABAC parameters of each context may be trained using data-driven methods. In some examples, initial CABAC parameters of a context are input to a data-driven method, and an output of the data-driven method includes the CABAC parameter of the context. In some examples, such as in various video coding standards, initial CABAC parameters of a context are predefined in a standard and remain unchanged. For example, the initial CABAC parameters are hard-coded (e.g., as a table in an encoder and a decoder). In this disclosure, an entropy coding approach in video coding including flexible initial CABAC parameters is described, for example, the entropy coding approach includes methods of determining initial CABAC parameters of a context. In an aspect, initial CABAC parameters are explicitly signaled.

According to an aspect of the disclosure, a current binary symbol associated with a syntax element of a block is entropy coded using the CABAC based on a set of contexts. In an example, the syntax element is binarized into one or more binary symbols, for example, using the binarizer (401) in FIG. 4. One of the one or more binary symbols is the current binary symbol. In an example, each context in the set of contexts corresponds to a probability estimation model for the CABAC. In an aspect, more than one set of initial CABAC parameters (e.g., more than one set of predefined initial CABAC parameters), such as a plurality sets of initial CABAC parameters of a context in the set of contexts is used. A set of initial CABAC parameters is determined from the plurality sets of initial CABAC parameters of the context in the set of contexts. In an example, the current binary symbol is entropy decoded using the CABAC based on the determined set of initial CABAC parameters.

In an example, the set of initial CABAC parameters is trained to determine a final set of initial CABAC parameters, and the current binary symbol is entropy decoded using the CABAC based on the final set of initial CABAC parameters.

In an example, the plurality sets of initial CABAC parameters of the context in the set of contexts is available to the encoder and the decoder, for example, the plurality sets of initial CABAC parameters is hardcoded.

In an aspect, the set of initial CABAC parameters used the context in the set of contexts is determined (e.g., selected) based on different types of coding information. In some examples, the different types of coding information include one or more of (i) a content type; (ii) a resolution of a picture that includes the block; (iii) a quantization parameter (QP) value; (iv) an encoding configuration (e.g., whether the encoding configuration is an all intra configuration, a random-access configuration, or a low-delay configuration); and (v) a temporal identification (ID). In an example, the set of initial CABAC parameters is determined from the plurality sets of initial CABAC parameters of the context based on one or more of (i) the content type; (ii) the resolution of the picture that includes the block; (iii) the QP value; (iv) whether the encoding configuration is an all intra configuration, a random-access configuration, or a low-delay configuration; and (v) the temporal identification (ID) in the coding information.

In one example, the set of initial CABAC parameters is determined based on the content type (e.g., a natural content, a screen content, or the like). In an aspect, natural content refers to content captured from the real world, for example, using cameras. In some examples, characteristics of natural content include complex textures and gradients (e.g., smooth color transitions, complex textures, and varying lighting conditions), noise, film grain, continuous tone (e.g., color and intensity values change smoothly across an image), and/or the like. In some examples, screen content is computer-generated from digital sources such as computer screens, presentations, video games, or user interfaces. In some examples, characteristics of screen content include one or more of sharp edges and text (e.g., screen content includes sharp transitions, such as text, graphics, and icons, with little or no blurring), limited color palette (e.g., screen content may include large areas of uniform color and a limited set of distinct colors), repetitive patterns (e.g., patterns such as grids, windows, or repeated icons are common in some examples), and/or the like.

In one example, the set of initial CABAC parameters is determined based on the resolution, such as the picture resolution (e.g., a 4K sequence, a High Definition (HD) sequence, or the like). In an example, a 4K video sequence refers to a video with a picture resolution of 3840 pixels×2160 pixels. In an example, an HD video sequence has a picture resolution of 1920 pixels×1080 pixels.

In one example, the set of initial CABAC parameters is determined based on the QP value. The QP value indicates a quantization step size used in the quantization. In an example, transform coefficients are quantized based on the QP value, and the quantized transform coefficients are encoded, and thus the QP value controls a degree of quantization applied to the transform coefficients. In various examples, a lower QP value indicates less quantization, which preserves more detail and results in higher video quality with a larger file size, and a higher QP value indicates more quantization, which reduces file size with lower video quality. In an example, the QP value is an integer such as one in a range from 0 to 63.

In one example, the set of initial CABAC parameters is determined based on the encoding configuration (e.g., all intra or random-access configurations). In an example, in the all-intra configuration, every frame (or picture) in a video sequence is encoded as an intra frame (I-frame) or I picture. In an example, intra frames are compressed independently, without reference to any other frames. In an example, the random-access configuration uses a mix of intra frames (I-frames) or I pictures, predicted frames (P-frames) or P pictures, and bi-predicted frames (B-frames) or B pictures. I-frames are inserted periodically, allowing the decoder to start decoding from these points. Between I-frames, P-frames and B-frames use temporal prediction to improve compression. Inter-frame prediction techniques may be used in the random-access configuration and the low-delay configuration. Some inter-frame prediction techniques may be restricted to reduce latency in the low-delay configuration. In an example, the determination of which encoding configuration is used is made at a sequence level. The encoding configuration that is selected is signaled in a sequence parameter set (SPS).

In an aspect, pictures are encoded into a video bitstream that includes one or more layers (e.g., temporal layers) with different qualities. In an example, the temporal ID is a numerical identifier associated with a Network Abstraction Layer (NAL) unit in the video bitstream. In an example, the temporal ID indicates a temporal layer to which the NAL unit belongs. In one example, the set of initial CABAC parameters is determined based on the temporal ID.

In one example, the set of initial CABAC parameters is determined based on the combination of one or more types of information such as described above, including the content type, the resolution, the QP value, the encoding configuration, the temporal ID, and the like.

In an example, the set of initial CABAC parameters is determined at a suitable level, such as a slice level, a CTU level, or the like.

In an aspect, the set of initial CABAC parameters used in the video bitstream is signaled.

In one example, the more than one set of initial CABAC parameters (e.g., the plurality sets of initial CABAC parameters) is provided, and an index of the set of initial CABAC parameters (e.g., the best set) is signaled in the video bitstream. For example, the set of initial CABAC parameters is determined from the plurality sets of initial CABAC parameters of the context based on the index signaled in the video bitstream, and the index indicates the set of initial CABAC parameters in the plurality sets of initial CABAC parameters of the context.

In one example, the set of initial CABAC parameter is determined from the plurality sets of initial CABAC parameters, such as described above. The set of initial CABAC parameter that is determined is further refined using additional signaling. For example, refinements (or modifications) to one or more initial CABAC parameters in the determined set of initial CABAC parameters are signaled in the video bitstream. In an example, the video bitstream includes refinement information of the one or more initial CABAC parameters in the set of initial CABAC parameters. The one or more initial CABAC parameters in the set of initial CABAC parameters are refined based on the refinement information. The refined set of initial CABAC parameters is trained to determine a final set of initial CABAC parameters, and the current binary symbol is entropy decoded, based on the final set of initial CABAC parameters using the CABAC.

In an aspect, one or more initial CABAC parameters in the set of initial CABAC parameters of the context in the set of contexts are explicitly signaled in the video bitstream. For example, the one or more initial CABAC parameters in the set of initial CABAC parameters of the context in the set of contexts are updated based on parameter information signaled in the coding information to determine an updated set of initial CABAC parameters of the context. The updated set of initial CABAC parameters includes one or more updated initial CABAC parameters. The current binary symbol is entropy decoded using the CABAC based on the updated set of initial CABAC parameters.

In some examples, context number(s) and initial CABAC parameters of the corresponding context(s) are signaled in the video bitstream.

In some examples, a context number of the context in the set of contexts is determined based on the coding information.

In one example, the encoder determines the context numbers and associated initial CABAC parameters to signal. Then, the context numbers and the associated initial CABAC parameters are signaled in the video bitstream. In an example, the initial CABAC parameters are one or more of the parameters in the set of initial CABAC parameters used in the context model. The values of the initial CABAC parameters are signaled.

In one example, the decoder decodes the context numbers and the associated initial CABAC parameters signaled in the video bitstream. Then, the decoder decodes values of the signaled initial CABAC parameters from the video bitstream. The initial CABAC parameters of the corresponding context numbers are replaced accordingly. For example, the contexts include a first context. Information indicating the context number of the first context is signaled, and parameter(s) in a set of initial CABAC parameters of the first context are signaled in the video bitstream. Corresponding parameter(s) in the set of initial CABAC parameters are replaced by the signaled parameter(s).

In an example, the parameter information indicates one or more updated values for the one or more respective initial CABAC parameters, and the one or more initial CABAC parameters in the set of initial CABAC parameters are replaced with the one or more updated values.

In one example, the differences between the encoder-determined new initial CABAC parameters and existing initial CABAC parameters are signaled.

In an example, the decoder decodes the set of context numbers and initial CABAC parameters signaled in the video bitstream. Then, the decoder decodes difference values for the signaled initial CABAC parameters in the video bitstream. The initial CABAC parameters of the corresponding context numbers are updated accordingly by adding with the decoded difference value.

In an example, the parameter information indicates one or more difference values for the one or more respective initial CABAC parameters, and each difference value indicates a difference between the respective initial CABAC parameter and the respective updated initial CABAC parameter. The one or more updated initial CABAC parameters are determined based on the one or more respective difference values. Each updated initial CABAC parameter in the one or more updated initial CABAC parameters is determined based on a sum of the respective initial CABAC parameter and the respective difference value.

According to an aspect of the disclosure, an improved context-based probability estimation approach for entropy coding in video coding including a hybrid context with multiple probability update and/or parameter derivation methods is described.

In entropy coding, CABAC is widely used. In CABAC, in some examples, each syntax (e.g., a syntax element) may adaptively select a context to perform probability estimation. In some examples, a syntax element such as a flag is indicated by a binary symbol. In some examples, a syntax element is binarized into multiple binary symbols. In some examples, each context represents a probability estimation model with different internal parameters (e.g., CABAC parameters).

In some context implementations, one or more probability estimation windows with respective probability estimates \hat{p}₁, \hat{p}₂, . . . are used. A probability estimation window is also referred to as a window. In an example, multi-hypothesis probability estimation is applied where a probability is estimated by averaging multiple estimates with different window sizes as shown in Eq. (4) below. A final estimated probability p is a weighted average of \hat{p}₁, \hat{p}₂, . . . from the respective windows.

In an aspect, a recursive probability estimation rule is used to adjust a probability estimate after each binary symbol is coded (e.g., encoded or decoded), for example, a current probability estimate of a current binary symbol depends on a previous probability estimate of a previous binary symbol. In an example, the previous binary symbol is adjacent to the current binary symbol in an entropy coding order (e.g., an entropy encoding order or an entropy decoding order). Thus, the current probability estimate of the current binary symbol depends on probability estimates of a plurality of previous binary symbols. A probability estimation window size refers to an effective number of previous binary symbols (bins) that the probability estimation rule considers when updating its estimate of the probability for a given context. For example, the probability estimation window is a conceptual window that determines how many previous symbols influence the current probability estimate. In an example, the window size is implicitly determined by an update rate (also referred to as an adaptation rate) used in the probability estimation rule. A higher update rate corresponds to a smaller window size, and a lower update rate corresponds to a larger window size.

In some examples, a context uses a probability estimate with an exponential law, such as shown in Eq. (1).

$${\hat{p}}_{i}^{t} = ( 1 - {α}_{i} ) {\hat{p}}_{i}^{t - 1} + {α}_{i} {x}^{t} \qquad Eq . ( 1 )$$

Eq. (1) shows an example of a first probability estimate method that uses the exponential law. For an i-th probability estimation window (or the i-th window), a current probability estimate

$${\hat{p}}_{i}^{t}$$

of a current binary symbol (corresponding to a step t) depends on a previous probability estimate

$${\hat{p}}_{i}^{t - 1}$$

of a previous binary symbol (corresponding to a step (t-1)) and a symbol value x^{t} at the step t. αᵢ is a parameter that determines an update rate for the i-th window, and indicates a probability estimation window size of the i-th window. For example, αᵢ is the update rate, and is referred to as the exponential update rate.

According to an aspect of the disclosure, a hybrid context is used in CABAC. In hybrid context, a context corresponds to multiple probability update methods or multiple probability update rules. In addition to the exponential law probability estimate method (e.g., the first probability estimate method) described in Eq. (1), a second probability estimate method (e.g., a linear update) may be used. The second probability estimate method is described using Eq. (2).

$${\hat{p}}_{i}^{t} = max ( min ( {\hat{p}}_{i}^{t - 1} + {λ}_{i} ( 2 {x}^{t} - 1 ) , 1 ) , 0 ) \qquad Eq . ( 2 )$$

λᵢ is a parameter that determines an update rate, and indicates a probability estimation window size of the i-th window. For example, λᵢ is the update rate in Eq. (2), and is referred to as the linear update rate. In Eq. (2), the functions max( ) and min(x) indicate clipping operations. Without the clipping operations,

$${\hat{p}}_{i}^{t}$$

is proportional to

$${\hat{p}}_{i}^{t - 1} ,$$

and thus

$${\hat{p}}_{i}^{t}$$

is linearly related to

$${\hat{p}}_{i}^{t - 1} .$$

In some examples, the multiple probability update methods include a third probability estimate method described in Eq. (3). In the third probability estimate method, a fast saturation rule may be used in each probability estimation window. For the i-th window, saturation thresholds βᵢ and γᵢ are determined. The fast saturated probability estimate (denoted by

$${\tilde{p}}_{i}^{t} )$$

is given by Eq. (3).

$${\tilde{p}}_{i}^{t} = f ( x ) = \{ \begin{matrix}0 , & {\hat{p}}_{i}^{t} < {β}_{i} \\ 1 , & {\hat{p}}_{i}^{t} > {γ}_{i} \\ {\hat{p}}_{i}^{t} , & otherwise\end{matrix} \qquad Eq . ( 3 )$$

In an example, βᵢ is less than γᵢ. In an example, βᵢ and γᵢ depend on the context, and may change from one context to another context.

$${\hat{p}}_{i}^{t}$$

### in Eq. (3) may be

$${\hat{p}}_{i}^{t}$$

### in Eq (1),

$${\hat{p}}_{i}^{t}$$

in Eq. (2), or the like.

In an example, the final estimated probability \hat{p}^{t} of the current binary symbol is a weighted average of

$${\hat{p}}_{1}^{t} , {\hat{p}}_{2}^{t} ,$$

. . . as shown in Eq. (4).

$${\hat{p}}^{t} = ( {w}_{1} {\hat{p}}_{1}^{t} + {w}_{2} {\hat{p}}_{2}^{t} + … + {w}_{i} {\hat{p}}_{i}^{t} + … + {w}_{N} {\hat{p}}_{N}^{t} ) / N \qquad Eq . ( 4 )$$

N is a number of the probability estimation windows. w₁, w₂, . . . , wᵢ, . . . , w_{N} are the weights.

$${\hat{p}}_{i}^{t}$$

### in Eq. (4) may be

$${\hat{p}}_{i}^{t}$$

### in Eq. (1),

$${\hat{p}}_{i}^{t}$$

### in Eq. (2),

$${\tilde{p}}_{i}^{t}$$

in Eq. (3), or the like.

In an aspect, a current binary symbol associated with a syntax element of a block is entropy coded using CABAC based on a context with one or more probability estimation windows. One of (i) a probability update rule for one of the one or more probability estimation windows and (ii) at least one probability estimate parameter of the probability update rule is determined. The current binary symbol is entropy decoded using the CABAC based on the one of (i) the probability update rule and (ii) the probability estimate parameter of the probability update rule.

In an aspect, the probability update rule for the one of the one or more probability estimation windows is determined from a plurality of probability update rules. In an example, the plurality of probability update rules includes two of more of (i) the first probability update rule described using Eq. (1), (ii) the second probability update rule described using Eq. (2), (iii) the third probability update rule described using Eq. (3), and the like.

In an example, the probability update rule of a probability estimation window is selected from the plurality of probability update rules. In some examples, hybrid contexts are used where the probability update rule of the window is chosen independently. For example, a context has a first window and a second window. A first probability update rule is selected for the first window, for example, from Eqs. (1)-(3). A second probability update rule is selected for the second window, for example, from Eqs. (1)-(3). In an example, the first probability update rule (e.g., Eq. (1)) is different from the second probability update rule (e.g., Eq. (2)). In an example, the first probability update rule is the same as the second probability update rule.

In some examples, the plurality of probability update rules includes (i) the first probability update rule (e.g., Eq. (1)) indicating the exponential relationship between the current probability estimate of the current binary symbol and the previous probability estimate of the previous binary symbol that is adjacent to the current binary symbol in an entropy decoding order; (ii) the second probability update rule (e.g., Eq. (2)) indicating the linear relationship between the current probability estimate of the current binary symbol and the previous probability estimate of the previous binary symbol; and (iii) the third probability update rule (e.g., Eq. (3)) that applies the fast saturated probability estimate.

In one example, the update rule (i.e., the probability update rule) of the probability estimation window is given by Eq. (1). In an example, a probability update rule of another window is given by one of Eqs. (1)-(3).

In one example, the update rule (i.e., the probability update rule) of the probability estimation window is given by Eq. (2).

In one example, the update rule (i.e., the probability update rule) of the probability estimation window is given by Eq. (3).

In one example, the update rule (i.e., the probability update rule) of each probability estimation window is hardcoded in both the encoder and the decoder.

In some examples, the probability update rule for the one of the one or more probability estimation windows is determined by the encoder and is signaled in the video bitstream. For example, a syntax element is signaled in the video bitstream to indicate the probability update rule. The probability update rule for the one of the one or more probability estimation windows is determined from the plurality of probability update rules based on the syntax element.

In one example, the update rule (i.e., the probability update rule) of each probability estimation window is determined (e.g., is chosen) by the encoder and is signaled in the video bitstream.

In one example, the update rule (i.e., the probability update rule) of each probability estimation window is hardcoded in both the encoder and the decoder. In an example, for the i-th probability estimation window, if the encoder determines that another probability update rule is to be used instead of the hardcoded rule for the i-th probability estimation window, the encoder signals to the decoder to use the other probability update rule for the i-th probability estimation window. In an example, a flag is signaled if the other probability update rule is determined by the encoder. If the flag is true, then the other update rule determined by the encoder is signaled in the video bitstream and is used for the i-th probability estimation window.

In an example, the probability update rule (such as described in Eq. (2)) indicates a linear relationship between the current probability estimate of the current binary symbol and the previous probability estimate of the previous binary symbol that is adjacent to the current binary symbol in the entropy decoding order. For example, the probability estimation is improved by using the linear probably estimate method as specified in Eq. (2).

In one example, the linear update rate λᵢ is hardcoded in both the encoder and the decoder. For example, λᵢ for each window is stored as a table in both the encoder and the decoder.

In one example, the linear update rate λᵢ is determined by the encoder and is signaled in the video bitstream.

In one example, the linear update rate λᵢ is hardcoded in both the encoder and the decoder. In an example, a flag is signaled if a new linear update rate λ_{i-New} is determined by the encoder. If the flag is true, then the encoder determined rate λ_{i-New} is signaled in the video bitstream. For example, the linear update rates λ₁ and λ₂ for the first window and the second window are hardcoded in both the encoder and the decoder. In an example, a flag is signaled if a new linear update rate λ_{1-New} for the first window is determined by the encoder. If the flag is true, then the encoder determined rate λ_{1-New} is signaled in the video bitstream and replaces λ₁ that is hardcoded.

In an aspect, the probability update rule applies a fast saturated probability estimate such as described in Eq. (3). For example, the probability estimation is improved by using the fast saturation rule probability estimate rule specified in Eq. (3).

In one example, the fast saturation rule is applied over the exponential law probability estimate rule specified in Eq. (1). For example,

$${\hat{p}}_{i}^{t}$$

in Eq. (3) is from Eq. (1).

In one example, the fast saturation rule is applied over the linear probability estimate rule specified in Eq. (2). For example,

$${\hat{p}}_{i}^{t}$$

in Eq. (3) is from Eq. (2).

In one example, whether to use the fast saturation is hardcoded in both the encoder and the decoder.

In one example, whether to use the fast saturation is determined by the encoder and is signaled in the video bitstream.

In one example, whether to use the fast saturation is hardcoded in both the encoder and the decoder. In an example, a flag is signaled if the use of the fast saturation is determined by the encoder, and this determination by the encoder may overwrite the hardcoded choice.

In one example, the fast saturation thresholds βᵢ and γᵢ are hardcoded in both the encoder and the decoder.

In one example, the fast saturation thresholds βᵢ and γᵢ are both determined by the encoder and are signaled in the video bitstream.

In one example, the fast saturation thresholds βᵢ and γᵢ are hardcoded in both the encoder and the decoder. Flag(s) are signaled if an updated value of at least one of the threshold is determined by the encoder. If the flag(s) are true, then the encoder determined threshold value(s) are signaled in the video bitstream and may overwrite βᵢ and/or γᵢ.

In an aspect, one or more probability estimate parameters (or the at least one probability estimate parameter) are flexible.

In related technologies, the probability estimate parameters (e.g., all the probability estimate parameters) are hardcoded in both the encoder and the decoder. In an example, flag(s) are signaled in the video bitstream to indicate if one or more probability estimate parameters are determined by the encoder and are signaled in the video bitstream. If the flag(s) are true, the corresponding one or more probability estimate parameter(s) are then signaled in the video bitstream.

In some examples, the at least one probability estimate parameter of the probability update rule is determined. For example, the at least one probability estimate parameter is determined by the encoder and is signaled in the video bitstream.

In an example, the coding information in the video bitstream includes a flag indicating that parameter information indicating the at least one probability estimate parameter of the probability update rule is signaled in the video bitstream. The at least one probability estimate parameter of the probability update rule is determined based on the parameter information.

In an example, the at least one probability estimate parameter (αᵢ in Eq. (1) or λᵢ in Eq. (2)) indicates a window size of the one of the one or more probability estimation windows. The at least one probability estimate parameter (αᵢ in Eq. (1) or λᵢ in Eq. (2)) is determined by the encoder and is signaled in the video bitstream.

In one example, the one or more signaled probability estimate parameters refer to the update rate αᵢ in Eq. (1) or the update rate λᵢ in Eq. (2), and the update rate αᵢ in Eq. (1) or the update rate λᵢ in Eq. (2) is determined by the encoder and is signaled in the video bitstream.

In one example, the one or more signaled probability estimate parameters refer to the thresholds βᵢ and γᵢ in Eq. (3), and the thresholds βᵢ and γᵢ in Eq. (3) are determined by the encoder and are signaled in the video bitstream. When the probability update rule applies a fast saturated probability estimate, the at least one probability estimate parameter indicates at least one saturation threshold (e.g., βᵢ and/or γᵢ) of the one of the one or more probability estimation windows.

In one example, the one or more signaled probability estimate parameters refer to the weights w₁, w₂, . . . , wᵢ, . . . used in Eq. (4) when averaging the probability estimate values from the windows of the context. The weights used in Eq. (4) are determined by the encoder and are signaled in the video bitstream. For example, the one or more probability estimation windows include multiple probability estimation windows. The current probability estimate for the current binary symbol is the weighted average of probability estimate values associated with the multiple probability estimation windows. The at least one probability estimate parameter indicates weights used in the weighted average.

This disclosure describes an entropy coding approach in video coding where the probability estimation for arithmetic coding is performed using learning based methods. The learning based methods may be used for context derivation. The parameters/weights of the learning based methods may be hard-coded (in both the encoder and the decoder) or signaled in the video bitstream. The learning based methods use coding block features as an input. The input may include feature vectors acquired from a current coding block and neighbors of the current coding block, and/or the state of probability estimation models.

Arithmetic coding is widely used in the entropy coding stage of many coding algorithms. When encoding a symbol (or a binary symbol), a number of bits used by arithmetic coding may achieve the lower bound given by information theory, when the probability distribution of the symbol is accurately estimated. In video coding, CABAC is widely used due to its high coding efficiency. A syntax or a syntax element corresponds to a binary symbol or multiple binary symbols. In an example, a syntax element is a template based intra mode derivation (TIMD) flag which is represented using a binary symbol.

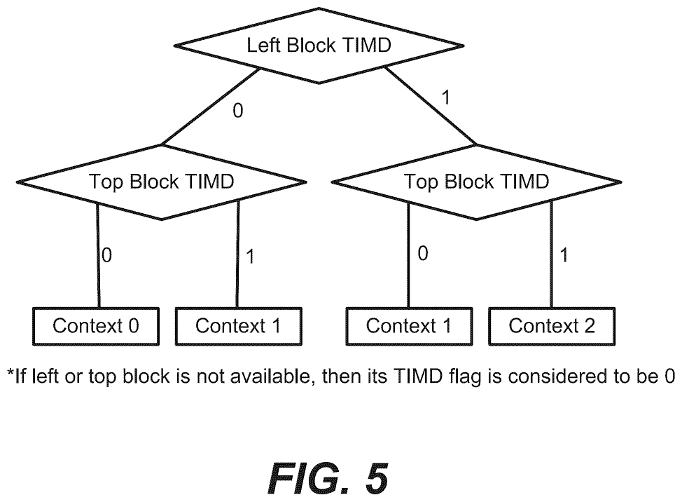

In CABAC, the probability estimation of each syntax can be conducted adaptively by one or more probability models known as “contexts”. In some examples, the choice of context (a process known as “context derivation”) is based on value(s) of previously coded syntax, for example, including previously coded syntax of neighboring blocks of the current coding block. In some examples, the context derivation rule is hand-crafted based on empirical observations, for example, the context derivation rule is manually derived and is not based on machine learning. For example, the TIMD flag derivation rules such as in ECM are shown in FIG. 5.

FIG. 5 shows an example of a context derivation rule for a syntax element such as the TIMD flag according to an aspect of the disclosure. A current context for the syntax element (e.g., the TIMD flag) for the current coding block is to be determined. In this example, the context derivation rule is fixed as shown in FIG. 5 and described as below. If the TIMD flag of the left block of the current coding block is 0 and the TIMD flag of the top block of the current coding block is 0, the current context is a “Context 0”. If the TIMD flag of the left block of the current coding block is 0 and the TIMD flag of the top block of the current coding block is 1, the current context is a “Context 1”. If the TIMD flag of the left block of the current coding block is 1 and the TIMD flag of the top block of the current coding block is 0, the current context is a “Context 1”. If the TIMD flag of the left block of the current coding block is 1 and the TIMD flag of the top block of the current coding block is 1, the current context is a “Context 2”. In an example, if the left block or the top block is not available, its TIMD flag is considered to be 0.

In CABAC design of related technologies, each context is a state machine that uses symbol value(s) as input and gives an estimated probability value as an output. Based on each symbol value, the context may change its estimated probability value according to a set of trained parameters (known as “context parameters”) that are associated with the context. In some examples, the context parameters determine the initial probability estimation value and how much the estimated probability changes given input symbol values.

According to an aspect of the disclosure, the probability estimation framework in video coding is improved using learning based approaches. The learning based approaches use feature vector(s) known as coding block features as an input. In an aspect, the coding block features include information related to the current syntax and additional information (e.g., related syntaxes, block sizes of the current block, the neighboring blocks of the current block, and non-neighboring blocks associated with the current block, a block location such as a relative block location of the current block in a CTU or in a picture, state(s) of probability estimation models (e.g., a state of a probability estimation model indicates a current probability estimate of a symbol), previously coded symbol values, and/or the like) that can improve probability estimation quality (which are determined using statistical analysis).

In some examples, the related syntaxes are statistically correlated to the current syntax. In an example, for a TIMD flag, flags indicating other intra prediction modes such as a DIMD flag, an IntraTMP flag are statistically correlated to the TIMD flag.

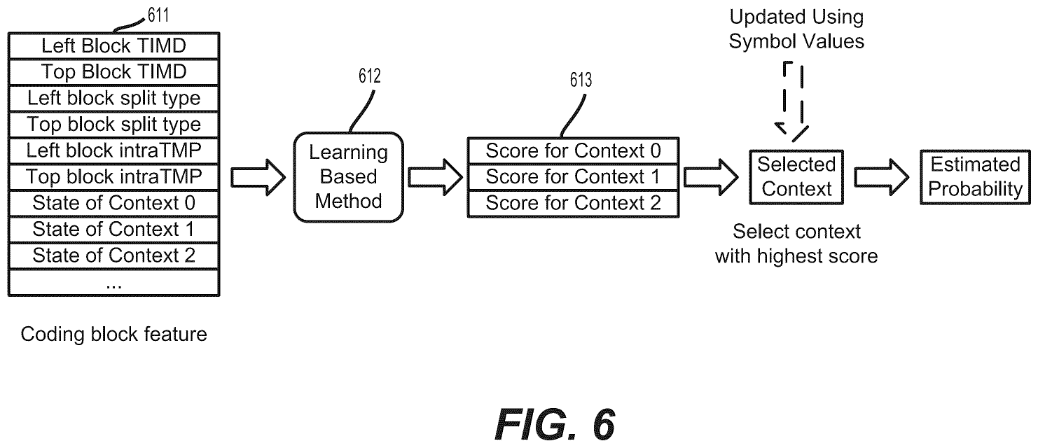

The coding block features are acquired from the current coding block, its neighbors, and/or the non-neighboring blocks associated with the current coding block. In an aspect, context derivation is conducted using learning based methods. The output of the learning based methods is a context identifier (ID), and the probability estimation is conducted with the context associated with the context ID, as shown in FIG. 6.

FIG. 6 shows an example of using the learning based methods for context derivation according to an aspect of the disclosure. Referring to FIG. 6, the coding block features include the TIMD flag of the left block that is to the left of the current block, the TIMD flag of the top block that is above the current block, a split type of the left block, a split type of the top block, an IntraTMP flag of the left block, an IntraTMP flag of the top block, states of respective contexts (e.g., a state of a Context 0, a state of a Context 1, a state of a Context 2, and the like), and/or the like. In an example shown in FIG. 6, a feature vector (611) is formed based on the coding block features. The feature vector (611) is an input to the learning based method (612). An output (613) of the learning based method (612) includes scores of the respective contexts (e.g., Context 0-2). In some examples, a context is selected from the contexts based on the scores. For example, the context with the highest score is selected from the contexts. In some examples, the context selection is updated using symbol values. An estimated probability is determined based on the selected context.

The learning based method may be based on, including but not limited to, a matrix multiplication, a Support Vector Machine (SVM), regression trees, neural networks, and the like. The parameters/weights of the learning based method may be hard-coded (in both the encoder and the decoder) or signaled in the video bitstream.

In some examples of the matrix multiplication, the input features (e.g., binary or real-valued features) are represented as a feature vector such as the feature vector (611) shown in FIG. 6. The feature vector is multiplied with a weight matrix learned from data to produce a new vector (e.g., the output (613) in FIG. 6). The new vector is then mapped to a context (e.g., the context with the highest score) used by the CABAC.

In some examples, the regression trees (or decision trees) are non-linear models that recursively partition the feature space into regions with similar output values. In the CABAC, regression trees are used to map input features to context indices. In some examples, the tree includes nodes that split the data based on feature thresholds. For a given input, the tree is traversed from the root to a leaf node by evaluating feature-based conditions at each node. The leaf node reached includes the context index used by CABAC.

In some examples, supervised learning models are used for classification and regression. In CABAC, an SVM is trained to classify the coding environment into different context classes based on input features. The SVM is trained on labeled data, where each sample includes features and an optimal context index. For a new input, the SVM computes a decision function to assign the input to a context class. The predicted class label from the SVM is used as the context index for CABAC.

In some examples, a neural network is trained to predict the optimal context index from a set of input features. In some examples, the neural network includes an input layer (for features), one or more hidden layers (for non-linear transformations), and an output layer (for context index prediction). The neural network is trained on labeled data using backpropagation to minimize the prediction error. For a new input, the neural network outputs a context index or a probability distribution over possible contexts. Neural networks may automatically learn feature representations and are suited for scenarios where the mapping from features to context is highly non-linear and complex.

According to an aspect of the disclosure, one or more learning based methods are used for context derivation for a syntax (or a syntax element). The one or more learning based methods use coding block features as an input and outputs a score for each available context such as shown in FIG. 6. The context with the highest score is selected.

In one example, the coding block features include information about the current coding block, the neighboring block(s) of the current coding block, the non-neighboring block(s) of the current coding block, the state(s) of the probability models associated with the contexts, and previous symbol values.

In one example, the learning based method is based on the matrix multiplication.

In one example, the learning based method is based on the regression trees.

In one example, the learning based method is based on the SVM(s).

In one example, the learning based method is based on the neural networks.

In one example, multiple learning based methods such as described in the disclosure are provided, and the choice of the learning based method is signaled in the video bitstream. For example, the encoder selects the learning based method for a syntax from the multiple learning based methods for the syntax and signals the selected learning based method in the video bitstream. In an example, the selection of the learning based method is syntax specific, and the derivation for a first syntax is different from the derivation for a second syntax.

In one example, the learning based methods are hard-coded in both the encoder and the decoder. For example, information indicating a relationship between syntaxes and corresponding learning based methods is stored in both the encoder and the decoder.

In one example, the parameters/weights of the learning based method(s) for a syntax are signaled in the video bitstream. In an example, a learning based method is to be used for the syntax, the parameters/weights of the learning based method for the syntax are signaled in the video bitstream.

In an aspect, multiple types of probability estimation methods including the learning based method(s) such as shown in FIG. 6 and non-learning based method(s) such as shown in FIG. 5 are combined. In an aspect, for each syntax, the multiple types of probability estimation methods (e.g., the learning based methods or non-learning based methods) are provided, and the type of probability estimation method used may be hard-coded in both the encoder and the decoder, or signaled in the bitstream.

In one example, the probability estimation method (e.g., such as the non-learning based method in FIG. 5) is hand-crafted in a video coding software.

In one example, the probability estimation method uses one or more of the learning based methods to derive context such as shown in FIG. 6.

In an aspect, each syntax has a respective learning based model for context derivation.

In an aspect, multiple syntaxes share the same learning based model for context derivation. The output of the learning based model is an offset value related to the first context ID associated with the syntax. The final context ID used is a sum of the first context ID associated with the syntax and the offset output by the learning based model.

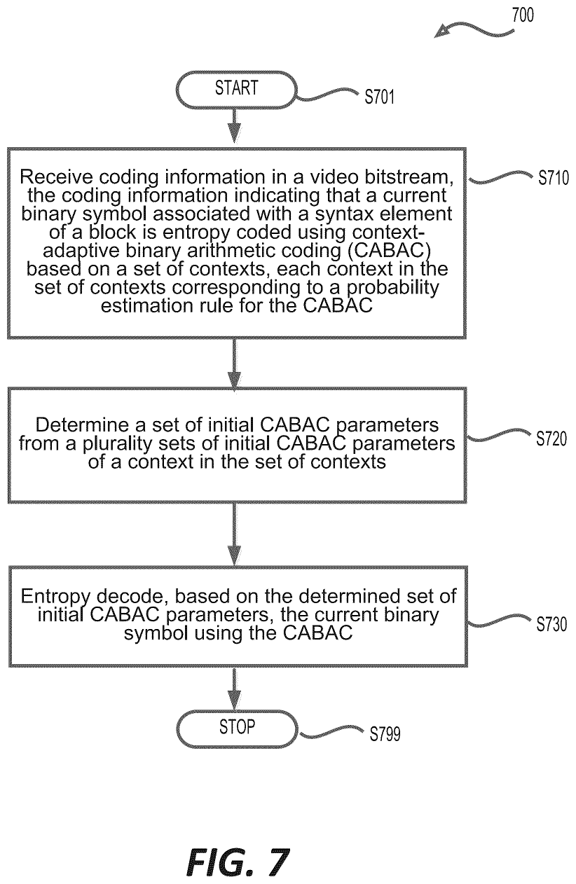

FIG. 7 shows a flow chart outlining a process (700) according to an aspect of the disclosure. The process (700) may be used in an apparatus, such as a video decoder. In various aspects, the process (700) is executed by processing circuitry, such as the processing circuitry that performs functions of the video decoder (110), the processing circuitry that performs functions of the video decoder (210), and the like. In some aspects, the process (700) is implemented in software instructions, thus when the processing circuitry executes the software instructions, the processing circuitry performs the process (700). The process starts at (S2101) and proceeds to (S710).

At (S710), coding information in a video bitstream is received. The coding information indicates that a current binary symbol associated with a syntax element of a block is entropy coded using context-adaptive binary arithmetic coding (CABAC) based on a set of contexts. Each context in the set of contexts corresponds to a probability estimation rule for the CABAC.

At (S720), a set of initial CABAC parameters is determined from a plurality sets of initial CABAC parameters of a context in the set of contexts.

In an example, the set of initial CABAC parameters is determined from the plurality sets of initial CABAC parameters of the context based on one or more of (i) a content type; (ii) a resolution of a picture that includes the block; (iii) a quantization parameter (QP) value; (iv) whether an encoding configuration is an all intra configuration, a random-access configuration, or a low-delay configuration; and (v) a temporal identification (ID) in the coding information.

In an example, the set of initial CABAC parameters is determined from the plurality sets of initial CABAC parameters of the context based on an index signaled in the video bitstream. The index indicates the set of initial CABAC parameters in the plurality sets of initial CABAC parameters of the context.

At (S730), the current binary symbol is entropy decoded based on the determined set of initial CABAC parameters using the CABAC.

In an example, the bitstream includes refinement information of one or more initial CABAC parameters in the set of initial CABAC parameters. The entropy decoding includes: refining the one or more initial CABAC parameters in the set of initial CABAC parameters based on the refinement information, training the refined set of initial CABAC parameters to determine a final set of initial CABAC parameters, and entropy decoding, based on the final set of initial CABAC parameters, the current binary symbol using the CABAC.

In an example, the entropy decoding includes training the set of initial CABAC parameters to determine a final set of initial CABAC parameters, and entropy decoding, based on the final set of initial CABAC parameters, the current binary symbol using the CABAC.

Then, the process proceeds to (S799) and terminates.

The process (700) may be suitably adapted. Step(s) in the process (700) may be modified and/or omitted. Additional step(s) may be added. Any suitable order of implementation may be used.

In an aspect, a current binary symbol associated with a syntax element of a block is entropy encoded using CABAC based on a set of contexts. Each context in the set of contexts corresponds to a probability estimation rule for the CABAC. A method for video encoding includes determining a set of initial CABAC parameters from a plurality sets of initial CABAC parameters of a context in a set of contexts, and entropy encoding, based on the determined set of initial CABAC parameters, the current binary symbol using the CABAC.

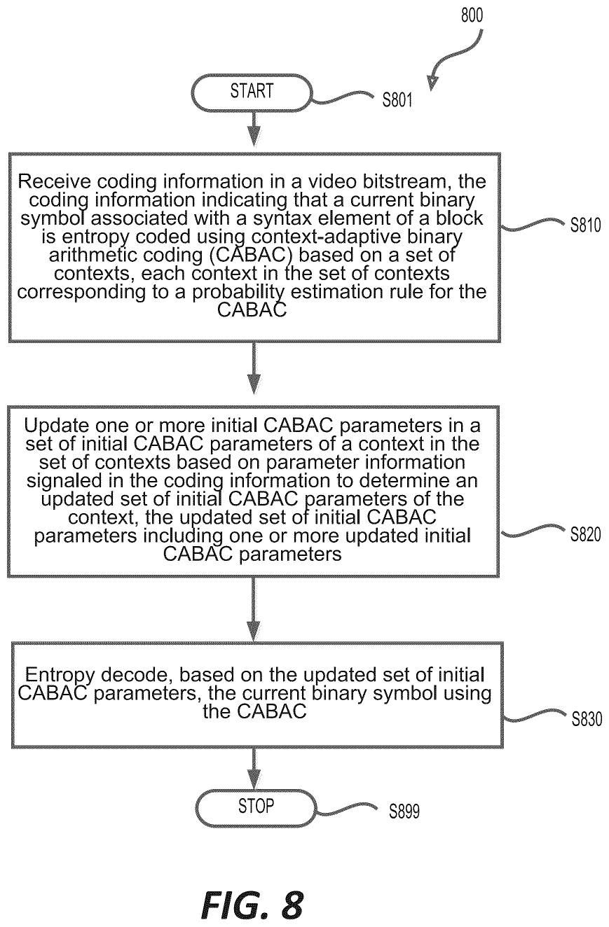

FIG. 8 shows a flow chart outlining a process (800) according to an aspect of the disclosure. The process (800) can be used in an apparatus, such as a video encoder. In various aspects, the process (800) is executed by processing circuitry, such as the processing circuitry that performs functions of the video encoder (103), the processing circuitry that performs functions of the video encoder (303), and the like. In some aspects, the process (800) is implemented in software instructions, thus when the processing circuitry executes the software instructions, the processing circuitry performs the process (800). The process starts at (S801) and proceeds to (S810).

At (S810), coding information in a video bitstream is received. The coding information indicates that a current binary symbol associated with a syntax element of a block is entropy coded using context-adaptive binary arithmetic coding (CABAC) based on a set of contexts. Each context in the set of contexts corresponds to a probability estimation rule for the CABAC.

At (S820), one or more initial CABAC parameters in a set of initial CABAC parameters of a context in the set of contexts are updated based on parameter information signaled in the coding information to determine an updated set of initial CABAC parameters of the context. The updated set of initial CABAC parameters includes one or more updated initial CABAC parameters.

In an example, the parameter information indicates one or more updated values for the one or more respective initial CABAC parameters, and the updating the one or more initial CABAC parameters includes replacing the one or more initial CABAC parameters in the set of initial CABAC parameters with the one or more updated values.

In an example, the parameter information indicates one or more difference values for the one or more respective initial CABAC parameters. Each difference value indicates a difference between the respective initial CABAC parameter and the respective updated initial CABAC parameter. The updating the one or more initial CABAC parameters includes determining the one or more updated initial CABAC parameters based on the one or more respective difference values. Each updated initial CABAC parameter in the one or more updated initial CABAC parameters is determined based on a sum of the respective initial CABAC parameter and the respective difference value.

At (S830), the current binary symbol entropy decoded using the CABAC based on the updated set of initial CABAC parameters.

Then, the process proceeds to (S899) and terminates.

The process (800) may be suitably adapted. Step(s) in the process (800) may be modified and/or omitted. Additional step(s) may be added. Any suitable order of implementation may be used.

In an example, a context number of the context in the set of contexts is determined based on the coding information.

In an aspect, a current binary symbol associated with a syntax element of a block is entropy encoded using CABAC based on a set of contexts. Each context in the set of contexts corresponds to a probability estimation rule for the CABAC. A method for video encoding includes updating one or more initial CABAC parameters in a set of initial CABAC parameters of a context in the set of contexts based on parameter information signaled in the coding information to determine an updated set of initial CABAC parameters of the context, where the updated set of initial CABAC parameters includes one or more updated initial CABAC parameters, and entropy encoding, based on the updated set of initial CABAC parameters, the current binary symbol using the CABAC.

In related technologies, the initial CABAC parameters of a context are predefined and remain unchanged, and thus may not be optimized. Benefits of the flexible initial CABAC parameters described such as with references to FIGS. 7-8 are described below. According to an aspect of the disclosure, a plurality sets of initial CABAC parameters of a context is available, and thus a set of initial CABAC parameters is selected from the plurality sets of initial CABAC parameters. In another example, one or more initial CABAC parameters in a set of initial CABAC parameters are refined (e.g., modified). In the flexible approaches described in the disclosure, a set of initial CABAC parameters is flexible (e.g., changeable) based on coding information, and thus may be more optimized for the specific context and the symbol to be entropy coded.

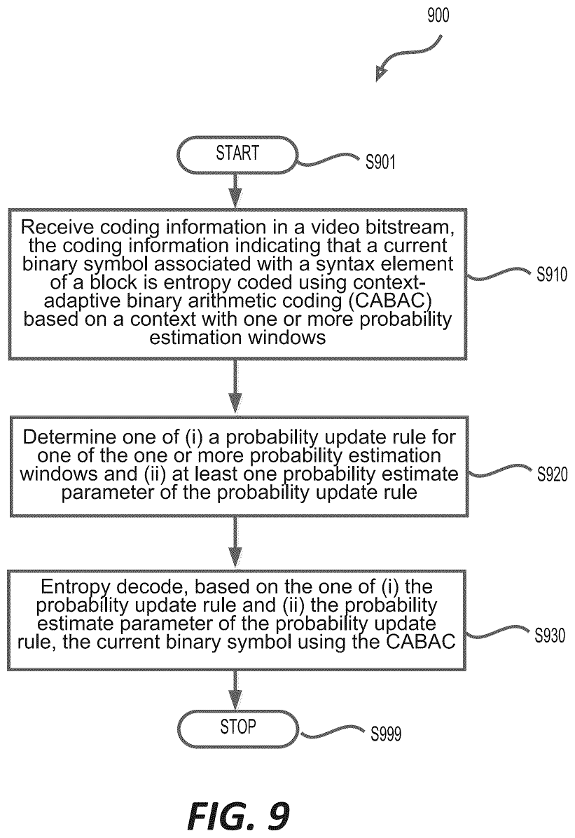

FIG. 9 shows a flow chart outlining a process (900) according to an aspect of the disclosure. The process (900) may be used in an apparatus, such as a video decoder. In various aspects, the process (900) is executed by processing circuitry, such as the processing circuitry that performs functions of the video decoder (110), the processing circuitry that performs functions of the video decoder (210), and the like. In some aspects, the process (900) is implemented in software instructions, thus when the processing circuitry executes the software instructions, the processing circuitry performs the process (900). The process starts at (S901) and proceeds to (S910).

At (S910), coding information in a video bitstream is received. The coding information indicates that a current binary symbol associated with a syntax element of a block is entropy coded using context-adaptive binary arithmetic coding (CABAC) based on a context with one or more probability estimation windows.

At (S920), one of (i) a probability update rule for one of the one or more probability estimation windows and (ii) at least one probability estimate parameter of the probability update rule is determined.

In an example, the probability update rule for the one of the one or more probability estimation windows is determined from a plurality of probability update rules.

In an example, the probability update rule indicates a linear relationship between a current probability estimate of the current binary symbol and a previous probability estimate of a previous binary symbol that is adjacent to the current binary symbol in an entropy decoding order.

In an example, the probability update rule applies a fast saturated probability estimate.

In an example, a syntax element is signaled in the video bitstream to indicate the probability update rule, and the probability update rule for the one of the one or more probability estimation windows from the plurality of probability update rules is determined based on the syntax element.

In an example, the plurality of probability update rules includes (i) a first probability update rule indicating an exponential relationship between a current probability estimate of the current binary symbol and a previous probability estimate of a previous binary symbol that is adjacent to the current binary symbol in an entropy decoding order; (ii) a second probability update rule indicating a linear relationship between the current probability estimate of the current binary symbol and the previous probability estimate of the previous binary symbol; and (iii) a third probability update rule that applies a fast saturated probability estimate.

In an example, the at least one probability estimate parameter of the probability update rule is determined from the coding information.

In an example, the at least one probability estimate parameter indicates a window size of the one of the one or more probability estimation windows.

In an example, the coding information includes a flag indicating that parameter information indicating the at least one probability estimate parameter of the probability update rule is signaled in the video bitstream, and the at least one probability estimate parameter of the probability update rule is determined based on the parameter information.

In an example, when the probability update rule applies a fast saturated probability estimate, the at least one probability estimate parameter indicates at least one saturation threshold of the one of the one or more probability estimation windows.

In an example, the one or more probability estimation windows include multiple probability estimation windows, a current probability estimate for the current binary symbol is a weighted average of probability estimate values associated with the multiple probability estimation windows, and the at least one probability estimate parameter indicates weights used in the weighted average.

At (S930), the current binary symbol is entropy decoded using the CABAC based on the one of (i) the probability update rule and (ii) the probability estimate parameter of the probability update rule.

Then, the process proceeds to (S999) and terminates.

The process (900) may be suitably adapted. Step(s) in the process (900) may be modified and/or omitted. Additional step(s) may be added. Any suitable order of implementation may be used.

In an aspect, a current binary symbol associated with a syntax element of a block is entropy encoded using CABAC based on a context with one or more probability estimation windows. A method for video encoding includes determining one of (i) a probability update rule for one of the one or more probability estimation windows and (ii) at least one probability estimate parameter of the probability update rule, and entropy encoding, based on the one of (i) the probability update rule and (ii) the probability estimate parameter of the probability update rule, the current binary symbol using the CABAC.

In related technologies, only one probability update rule with fixed parameters is used. Benefits of the hybrid context with multiple probability update rules and/or parameter derivation for a probability update rule described such as with references to FIG. 9 are described below. According to an aspect of the disclosure, a plurality of probability update rules is available, and a probability update rule is selected from the plurality of probability update rules are available. In another example, probability estimate parameter(s) of the probability update rule are flexible and are determined. Thus, the probability update rule determined using methods described in the disclosure is more optimized than the fixed probability update rule, and thus may result in better probability estimation.

In an aspect, a method of processing visual media data includes processing a video bitstream of the visual media data according to a format rule. For example, the bitstream may be a bitstream that is decoded/encoded in any of the decoding and/or encoding methods described herein. The format rule may specify one or more constraints of the bitstream and/or one or more processes to be performed by the decoder and/or encoder.

In an aspect, the video bitstream includes coding information indicating that a current binary symbol associated with a syntax element of a block is entropy coded using CABAC based on a set of contexts. Each context in the set of contexts corresponds to a probability estimation rule for the CABAC. The format rules specifies that a set of initial CABAC parameters is determined from a plurality sets of initial CABAC parameters of a context in the set of contexts, and the current binary symbol is entropy coded (e.g., entropy encoded or entropy decoded) using the CABAC based on the determined set of initial CABAC parameters.

In an aspect, the format rules specifies that one or more initial CABAC parameters in a set of initial CABAC parameters of a context in the set of contexts are updated based on parameter information signaled in the coding information to determine an updated set of initial CABAC parameters of the context. The updated set of initial CABAC parameters includes one or more updated initial CABAC parameters. The format rules specifies that the current binary symbol is entropy decoded using the CABAC based on the updated set of initial CABAC parameters.

In an aspect, the video bitstream includes coding information indicating that a current binary symbol associated with a syntax element of a block is entropy coded using CABAC based on a context with one or more probability estimation windows. The format rules specifies that one of (i) a probability update rule for one of the one or more probability estimation windows and (ii) at least one probability estimate parameter of the probability update rule is determined, and the current binary symbol is entropy decoded using the CABAC based on the one of (i) the probability update rule and (ii) the probability estimate parameter of the probability update rule.

Aspects of the disclosure also provide an apparatus for video decoding. The apparatus for video decoding includes processing circuitry configured to implement any of the described methods for video decoding.

Aspects of the disclosure also provide an apparatus for video encoding. The apparatus for video encoding includes processing circuitry configured to implement any of the described methods for video encoding.

Aspects of the disclosure also provide a non-transitory computer-readable medium storing instructions which, when executed by a computer, cause the computer to perform any of the described methods for video decoding/encoding.

A non-transitory computer-readable storage medium storing a video bitstream that is generated by a video encoding method is disclosed. The video encoding method includes any video encoding method or any combination of video encoding methods described in the disclosure.

Methods, aspects and/or examples in the disclosure may be used separately or combined in any order. For example, some aspects and/or examples performed by the decoder may be performed by the encoder and vice versa. Each of the methods (or aspects), an encoder, and a decoder may be implemented by processing circuitry (e.g., one or more processors or one or more integrated circuits). In one example, the one or more processors execute a program that is stored in a non-transitory computer-readable medium. The disclosed methods may be used in various codecs (e.g., video codecs) such as the codecs described in the disclosure.

The processes (or methods) described in the disclosure may be implemented in an image and/or video decoding process or an image and/or video encoding process. The decoding/encoding process may be used in a video decoder device. The decoding/encoding process may be used in a video encoder device. In some examples, the process is executed by processing circuitry, such as the processing circuitry that performs functions of the video decoder, the processing circuitry that performs functions of the video decoder, and the like. In some examples, the process is executed by processing circuitry, such as the processing circuitry that performs functions of the video encoder, the processing circuitry that performs functions of the video encoder, and the like. In some examples, the process is implemented in software instructions, thus when the processing circuitry executes the software instructions, the processing circuitry performs the process. In some examples, the process may be implemented on the chip as a hardware process, thus when the processing circuitry executes the hardware instructions, the processing circuitry performs the process. The process may be suitably adapted. Steps in the process as described in the disclosure may be modified and/or omitted. Additional steps may be added. Any suitable order of implementation may be used.

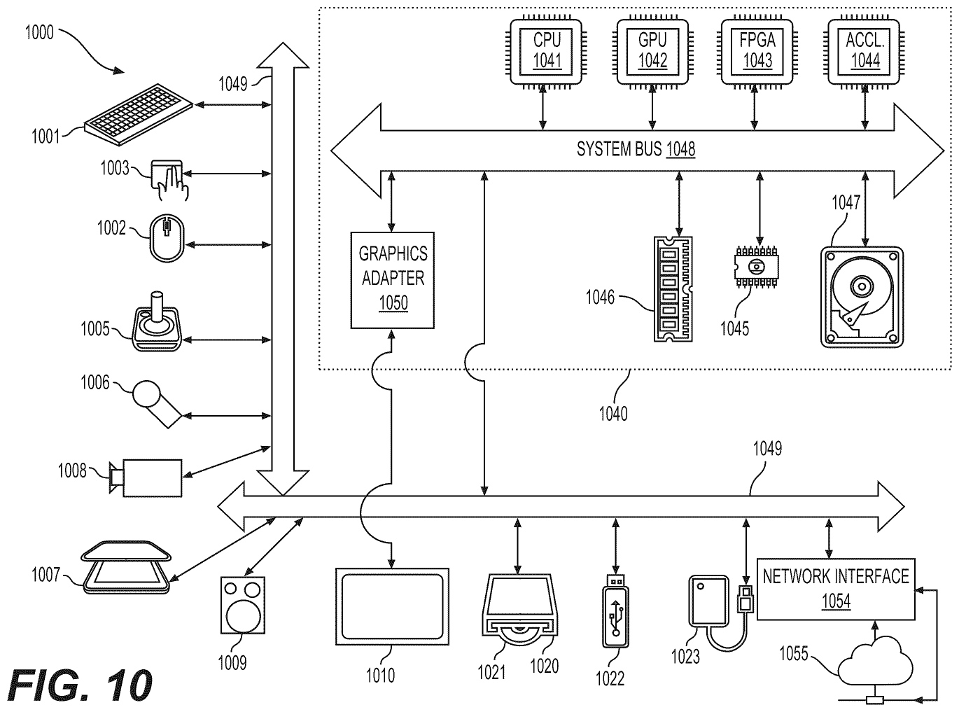

The techniques described above, may be implemented as computer software using computer-readable instructions and physically stored in one or more computer-readable media. For example, FIG. 10 shows a computer system (1000) suitable for implementing certain aspects of the disclosed subject matter.

The computer software may be coded using any suitable machine code or computer language, that may be subject to assembly, compilation, linking, or like mechanisms to create code comprising instructions that may be executed directly, or through interpretation, micro-code execution, and the like, by one or more computer central processing units (CPUs), Graphics Processing Units (GPUs), and the like.

The instructions may be executed on various types of computers or components thereof, including, for example, personal computers, tablet computers, servers, smartphones, gaming devices, internet of things devices, and the like.

The components shown in FIG. 10 for computer system (1000) are examples and are not intended to suggest any limitation as to the scope of use or functionality of the computer software implementing aspects of the present disclosure. Neither should the configuration of components be interpreted as having any dependency or requirement relating to any one or combination of components illustrated in the example aspect of a computer system (1000).

Computer system (1000) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices may also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (1001), mouse (1002), trackpad (1003), touch screen (1010), data-glove (not shown), joystick (1005), microphone (1006), scanner (1007), camera (1008).

Computer system (1000) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (1010), data-glove (not shown), or joystick (1005), but there may also be tactile feedback devices that do not serve as input devices), audio output devices (such as: speakers (1009), headphones (not depicted)), visual output devices (such as screens (1010) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (1000) may also include human accessible storage devices and their associated media such as optical media including CD/DVD ROM/RW (1020) with CD/DVD or the like media (1021), thumb-drive (1022), removable hard drive or solid state drive (1023), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (1000) may also include an interface (1054) to one or more communication networks (1055). Networks may for example be wireless, wireline, optical. Networks may further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (1049) (such as, for example USB ports of the computer system (1000)); others are commonly integrated into the core of the computer system (1000) by attachment to a system bus as described below (for example Ethernet interface into a PC computer system or cellular network interface into a smartphone computer system). Using any of these networks, computer system (1000) may communicate with other entities. Such communication may be uni-directional, receive only (for example, broadcast TV), uni-directional send-only (for example CANbus to certain CANbus devices), or bi-directional, for example to other computer systems using local or wide area digital networks. Certain protocols and protocol stacks may be used on each of those networks and network interfaces as described above.

Aforementioned human interface devices, human-accessible storage devices, and network interfaces may be attached to a core (1040) of the computer system (1000).

The core (1040) may include one or more Central Processing Units (CPU) (1041), Graphics Processing Units (GPU) (1042), specialized programmable processing units in the form of Field Programmable Gate Areas (FPGA) (1043), hardware accelerators for certain tasks (1044), graphics adapters (1050), and so forth. These devices, along with Read-only memory (ROM) (1045), Random-access memory (1046), internal mass storage such as internal non-user accessible hard drives, SSDs, and the like (1047), may be connected through a system bus (1048). In some computer systems, the system bus (1048) may be accessible in the form of one or more physical plugs to enable extensions by additional CPUs, GPU, and the like. The peripheral devices may be attached either directly to the core's system bus (1048), or through a peripheral bus (1049). In an example, the screen (1010) may be connected to the graphics adapter (1050). Architectures for a peripheral bus include PCI, USB, and the like.

CPUs (1041), GPUs (1042), FPGAs (1043), and accelerators (1044) may execute certain instructions that, in combination, may make up the aforementioned computer code. That computer code may be stored in ROM (1045) or RAM (1046). Transitional data may also be stored in RAM (1046), whereas permanent data may be stored for example, in the internal mass storage (1047). Fast storage and retrieve to any of the memory devices may be enabled through the use of cache memory, that may be closely associated with one or more CPU (1041), GPU (1042), mass storage (1047), ROM (1045), RAM (1046), and the like.

The computer readable media may have computer code thereon for performing various computer-implemented operations. The media and computer code may be those specially designed and constructed for the purposes of the present disclosure, or they may be of the kind well known and available to those having skill in the computer software arts.

As an example and not by way of limitation, the computer system having architecture (1000), and specifically the core (1040) may provide functionality as a result of processor(s) (including CPUs, GPUs, FPGA, accelerators, and the like) executing software embodied in one or more tangible, computer-readable media. Such computer-readable media may be media associated with user-accessible mass storage as introduced above, as well as certain storage of the core (1040) that are of non-transitory nature, such as core-internal mass storage (1047) or ROM (1045). The software implementing various aspects of the present disclosure may be stored in such devices and executed by core (1040). A computer-readable medium may include one or more memory devices or chips, according to particular needs. The software may cause the core (1040) and specifically the processors therein (including CPU, GPU, FPGA, and the like) to execute particular processes or particular parts of particular processes described herein, including defining data structures stored in RAM (1046) and modifying such data structures according to the processes defined by the software. In addition or as an alternative, the computer system may provide functionality as a result of logic hardwired or otherwise embodied in a circuit (for example: accelerator (1044)), which may operate in place of or together with software to execute particular processes or particular parts of particular processes described herein. Reference to software may encompass logic, and vice versa, where appropriate. Reference to a computer-readable media may encompass a circuit (such as an integrated circuit (IC)) storing software for execution, a circuit embodying logic for execution, or both, where appropriate. The present disclosure encompasses any suitable combination of hardware and software.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several examples of aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the features noted below. The features may be combined in various manners and are not limited to the combinations noted below.
(1) A method for video decoding, the method including: receiving coding information in a video bitstream, the coding information indicating that a current binary symbol associated with a syntax element of a block is entropy coded using context-adaptive binary arithmetic coding (CABAC) based on a set of contexts, each context in the set of contexts corresponding to a probability estimation rule for the CABAC; determining a set of initial CABAC parameters from a plurality sets of initial CABAC parameters of a context in the set of contexts; and entropy decoding, based on the determined set of initial CABAC parameters, the current binary symbol using the CABAC.
(2) The method of feature (1), in which the determining the set of initial CABAC parameters includes: determining the set of initial CABAC parameters from the plurality sets of initial CABAC parameters of the context based on one or more of (i) a content type; (ii) a resolution of a picture that includes the block; (iii) a quantization parameter (QP) value; (iv) whether an encoding configuration is an all intra configuration, a random-access configuration, or a low-delay configuration; and (v) a temporal identification (ID) in the coding information.
(3) The method of feature (1), in which the determining the set of initial CABAC parameters includes: determining the set of initial CABAC parameters from the plurality sets of initial CABAC parameters of the context based on an index signaled in the video bitstream, the index indicating the set of initial CABAC parameters in the plurality sets of initial CABAC parameters of the context.
(4) The method of feature (1), in which the bitstream includes refinement information of one or more initial CABAC parameters in the set of initial CABAC parameters; and the entropy decoding includes: refining the one or more initial CABAC parameters in the set of initial CABAC parameters based on the refinement information; training the refined set of initial CABAC parameters to determine a final set of initial CABAC parameters; and entropy decoding, based on the final set of initial CABAC parameters, the current binary symbol using the CABAC.
(5) The method of any one of features (1)-(4), in which the entropy decoding includes: training the set of initial CABAC parameters to determine a final set of initial CABAC parameters; and entropy decoding, based on the final set of initial CABAC parameters, the current binary symbol using the CABAC.
(6) A method for video decoding, the method including: receiving coding information in a video bitstream, the coding information indicating that a current binary symbol associated with a syntax element of a block is entropy coded using context-adaptive binary arithmetic coding (CABAC) based on a set of contexts, each context in the set of contexts corresponding to a probability estimation rule for the CABAC; updating one or more initial CABAC parameters in a set of initial CABAC parameters of a context in the set of contexts based on parameter information signaled in the coding information to determine an updated set of initial CABAC parameters of the context, the updated set of initial CABAC parameters including one or more updated initial CABAC parameters; and entropy decoding, based on the updated set of initial CABAC parameters, the current binary symbol using the CABAC.
(7) The method of feature (6), further including: determining a context number of the context in the set of contexts based on the coding information.
(8) The method of feature (6) or (7), in which the parameter information indicates one or more updated values for the one or more respective initial CABAC parameters; and the updating includes replacing the one or more initial CABAC parameters in the set of initial CABAC parameters with the one or more updated values.
(9) The method of feature (6) or (7), in which the parameter information indicates one or more difference values for the one or more respective initial CABAC parameters, each difference value indicating a difference between the respective initial CABAC parameter and the respective updated initial CABAC parameter; and the updating includes determining the one or more updated initial CABAC parameters based on the one or more respective difference values, each updated initial CABAC parameter in the one or more updated initial CABAC parameters being determined based on a sum of the respective initial CABAC parameter and the respective difference value.
(10) A method for video decoding, the method including: receiving coding information in a video bitstream, the coding information indicating that a current binary symbol associated with a syntax element of a block is entropy coded using context-adaptive binary arithmetic coding (CABAC) based on a context with one or more probability estimation windows; determining one of (i) a probability update rule for one of the one or more probability estimation windows and (ii) at least one probability estimate parameter of the probability update rule; and entropy decoding, based on the one of (i) the probability update rule and (ii) the probability estimate parameter of the probability update rule, the current binary symbol using the CABAC.
(11) The method of feature (10), in which the determining includes: determining the probability update rule for the one of the one or more probability estimation windows from a plurality of probability update rules.
(12) The method of feature (10) or (11), in which the probability update rule indicates a linear relationship between a current probability estimate of the current binary symbol and a previous probability estimate of a previous binary symbol that is adjacent to the current binary symbol in an entropy decoding order.
(13) The method of feature (10) or (11), in which the probability update rule applies a fast saturated probability estimate.
(14) The method of feature (10) or (11), in which a syntax element is signaled in the video bitstream to indicate the probability update rule; and the determining includes determining, based on the syntax element, the probability update rule for the one of the one or more probability estimation windows from the plurality of probability update rules.
(15) The method of feature (10) or (11), in which the plurality of probability update rules includes (i) a first probability update rule indicating an exponential relationship between a current probability estimate of the current binary symbol and a previous probability estimate of a previous binary symbol that is adjacent to the current binary symbol in an entropy decoding order; (ii) a second probability update rule indicating a linear relationship between the current probability estimate of the current binary symbol and the previous probability estimate of the previous binary symbol; and (iii) a third probability update rule that applies a fast saturated probability estimate.
(16) The method of feature (10), in which the determining includes: determining the at least one probability estimate parameter of the probability update rule from the coding information.
(17) The method of feature (10) or (16), in which the at least one probability estimate parameter indicates a window size of the one of the one or more probability estimation windows.
(18) The method of feature (10) or (16), in which the coding information includes a flag indicating that parameter information indicating the at least one probability estimate parameter of the probability update rule is signaled in the video bitstream; and the determining the at least one probability estimate parameter includes determining the at least one probability estimate parameter of the probability update rule based on the parameter information.
(19) The method of feature (10) or (16), in which when the probability update rule applies a fast saturated probability estimate, the at least one probability estimate parameter indicates at least one saturation threshold of the one of the one or more probability estimation windows.
(20) The method of feature (10) or (16), in which the one or more probability estimation windows include multiple probability estimation windows; a current probability estimate for the current binary symbol is a weighted average of probability estimate values associated with the multiple probability estimation windows; and the at least one probability estimate parameter indicates weights used in the weighted average.
(21) An apparatus for decoding, including processing circuitry that is configured to perform the method of any of features (1) to (20).
(22) A non-transitory computer-readable storage medium storing instructions which when executed by at least one processor cause the at least one processor to perform the method of any of features (1) to (20).

What is claimed is:

1. A method for video decoding, the method comprising:
receiving coding information in a video bitstream, the coding information indicating that a current binary symbol associated with a syntax element of a block is entropy coded using context-adaptive binary arithmetic coding (CABAC) based on a set of contexts, each context in the set of contexts corresponding to a probability estimation rule for the CABAC;
determining a set of initial CABAC parameters from a plurality sets of initial CABAC parameters of a context in the set of contexts; and
entropy decoding, based on the determined set of initial CABAC parameters, the current binary symbol using the CABAC.

2. The method of claim 1, wherein the determining the set of initial CABAC parameters comprises:
determining the set of initial CABAC parameters from the plurality sets of initial CABAC parameters of the context based on one or more of (i) a content type; (ii) a resolution of a picture that includes the block; (iii) a quantization parameter (QP) value; (iv) whether an encoding configuration is an all intra configuration, a random-access configuration, or a low-delay configuration; and (v) a temporal identification (ID) in the coding information.

3. The method of claim 1, wherein the determining the set of initial CABAC parameters comprises:
determining the set of initial CABAC parameters from the plurality sets of initial CABAC parameters of the context based on an index signaled in the video bitstream, the index indicating the set of initial CABAC parameters in the plurality sets of initial CABAC parameters of the context.

4. The method of claim 1, wherein
the video bitstream includes refinement information of one or more initial CABAC parameters in the set of initial CABAC parameters; and
the entropy decoding includes:
refining the one or more initial CABAC parameters in the set of initial CABAC parameters based on the refinement information;
training the refined set of initial CABAC parameters to determine a final set of initial CABAC parameters; and
entropy decoding, based on the final set of initial CABAC parameters, the current binary symbol using the CABAC.

5. The method of claim 1, wherein the entropy decoding comprises:
training the set of initial CABAC parameters to determine a final set of initial CABAC parameters; and
entropy decoding, based on the final set of initial CABAC parameters, the current binary symbol using the CABAC.

6. A method for video decoding, the method comprising:
receiving coding information in a video bitstream, the coding information indicating that a current binary symbol associated with a syntax element of a block is entropy coded using context-adaptive binary arithmetic coding (CABAC) based on a set of contexts, each context in the set of contexts corresponding to a probability estimation rule for the CABAC;
updating one or more initial CABAC parameters in a set of initial CABAC parameters of a context in the set of contexts based on parameter information signaled in the coding information to determine an updated set of initial CABAC parameters of the context, the updated set of initial CABAC parameters including one or more updated initial CABAC parameters; and
entropy decoding, based on the updated set of initial CABAC parameters, the current binary symbol using the CABAC.

7. The method of claim 6, further comprising:
determining a context number of the context in the set of contexts based on the coding information.

8. The method of claim 7, wherein
the parameter information indicates one or more updated values for the one or more respective initial CABAC parameters; and
the updating includes replacing the one or more initial CABAC parameters in the set of initial CABAC parameters with the one or more updated values.

9. The method of claim 7, wherein
the parameter information indicates one or more difference values for the one or more respective initial CABAC parameters, each difference value indicating a difference between the respective initial CABAC parameter and the respective updated initial CABAC parameter; and
the updating includes determining the one or more updated initial CABAC parameters based on the one or more respective difference values, each updated initial CABAC parameter in the one or more updated initial CABAC parameters being determined based on a sum of the respective initial CABAC parameter and the respective difference value.

10. A method for video decoding, the method comprising:
receiving coding information in a video bitstream, the coding information indicating that a current binary symbol associated with a syntax element of a block is entropy coded using context-adaptive binary arithmetic coding (CABAC) based on a context with one or more probability estimation windows;
determining one of (i) a probability update rule for one of the one or more probability estimation windows and (ii) at least one probability estimate parameter of the probability update rule; and
entropy decoding, based on the one of (i) the probability update rule and (ii) the probability estimate parameter of the probability update rule, the current binary symbol using the CABAC.

11. The method of claim 10, wherein the determining comprises:
determining the probability update rule for the one of the one or more probability estimation windows from a plurality of probability update rules.

12. The method of claim 11, wherein the probability update rule indicates a linear relationship between a current probability estimate of the current binary symbol and a previous probability estimate of a previous binary symbol that is adjacent to the current binary symbol in an entropy decoding order.

13. The method of claim 11, wherein the probability update rule applies a fast saturated probability estimate.

14. The method of claim 11, wherein
a syntax element is signaled in the video bitstream to indicate the probability update rule; and
the determining comprises determining, based on the syntax element, the probability update rule for the one of the one or more probability estimation windows from the plurality of probability update rules.

15. The method of claim 11, wherein the plurality of probability update rules comprises (i) a first probability update rule indicating an exponential relationship between a current probability estimate of the current binary symbol and a previous probability estimate of a previous binary symbol that is adjacent to the current binary symbol in an entropy decoding order; (ii) a second probability update rule indicating a linear relationship between the current probability estimate of the current binary symbol and the previous probability estimate of the previous binary symbol; and (iii) a third probability update rule that applies a fast saturated probability estimate.

16. The method of claim 10, wherein the determining comprises:
determining the at least one probability estimate parameter of the probability update rule from the coding information.

17. The method of claim 16, wherein the at least one probability estimate parameter indicates a window size of the one of the one or more probability estimation windows.

18. The method of claim 16, wherein
the coding information includes a flag indicating that parameter information indicating the at least one probability estimate parameter of the probability update rule is signaled in the video bitstream; and
the determining the at least one probability estimate parameter includes determining the at least one probability estimate parameter of the probability update rule based on the parameter information.

19. The method of claim 16, wherein when the probability update rule applies a fast saturated probability estimate, the at least one probability estimate parameter indicates at least one saturation threshold of the one of the one or more probability estimation windows.

20. The method of claim 16, wherein
the one or more probability estimation windows include multiple probability estimation windows;
a current probability estimate for the current binary symbol is a weighted average of probability estimate values associated with the multiple probability estimation windows; and
the at least one probability estimate parameter indicates weights used in the weighted average.
